(19) United States
(12) Patent Application Publication
(10) Pub. No.: US 2026/0317480 A1
(43) Pub. Date: Oct. 15, 2026

(54) METHODS FOR PRODUCING AMIC ACID OLIGOMER POWDER, SEMIPREG, PREPREG, AND FIBER-REINFORCED COMPOSITE MATERIAL, AND AMIC ACID OLIGOMER POWDER

(71) Applicant: KANEKA CORPORATION, Osaka (JP)

(72) Inventor: Atsushi Kumasaki, Osaka (JP)

(73) Assignee: KANEKA CORPORATION, Osaka (JP)

(21) Appl. No.: 19/573,320

(22) Filed: Mar. 20, 2026

(30) Foreign Application Priority Data
Mar. 21, 2025 (JP) 2025-046940

(51) Int. Cl. C08G 73/06; B29C 70/08; D06M 15/37; D06M 15/705

(52) U.S. Cl. CPC C08G 73/06; B29C 70/08; D06M 15/37; D06M 15/705; C08G 2115/00

(57) ABSTRACT

Provided is a novel method for producing an amic acid oligomer powder, the novel method being different from a pulverization method and a reprecipitation method. A method for producing an amic acid oligomer powder according to the present disclosure includes a step of obtaining an amic acid oligomer powder by using a spray drying method to remove a solvent from a varnish of an amic acid oligomer, the amic acid oligomer powder containing a compound represented by a specific general formula.

This Nonprovisional application claims priority under 35 U.S.C. § 119 on Patent Application No. 2025-046940 filed in Japan on Mar. 21, 2025, the entire contents of which are hereby incorporated by reference.

### TECHNICAL FIELD

The present invention relates to a method for producing a polyamic acid (hereinafter also referred to as “amic acid oligomer”) powder having a specific composition, a method for producing a semipreg or a prepreg from the amic acid oligomer powder, and a method for producing a fiber-reinforced composite material from the semipreg or the prepreg. The present invention also relates to an amic acid oligomer powder.

### BACKGROUND ART

Polyimides have heat resistance of the highest level among polymers, and also have excellent mechanical characteristics, excellent electrical characteristics, and the like, and thus are used as raw materials in a wide range of fields including aerospace and electrical/electronic fields.

An imide oligomer in which a terminal(s) of a polyimide is/are capped with a terminal capping agent containing a functional group capable of an addition reaction has a lower molecular weight and more excellent melt flowability than what is generally called “polyimide”. Such an imide oligomer has conventionally been used as a matrix resin for a molded article and a fiber-reinforced composite material because a cured product of the imide oligomer exhibits high heat resistance.

In particular, an imide oligomer disclosed in Patent Literature 1 and having a terminal(s) capped with 4-(2-phenylethynyl)phthalic anhydride is said to have an excellent balance of moldability, heat resistance, and mechanical characteristics. For example, Patent Literature 1 discloses a terminally modified imide oligomer and a cured product thereof, the terminally modified imide oligomer being synthesized from raw material compounds including aromatic diamines including 2-phenyl-4,4′-diaminodiphenyl ether and aromatic tetracarboxylic acids and terminally modified with 4-(2-phenylethynyl)phthalic anhydride.

Patent Literature 2 discloses a thermosetting solution composition obtained by mixing together (A) an aromatic tetracarboxylic acid component containing not less than 20 mol % of a 2,3,3′,4′-biphenyltetracarboxylic acid compound, (B) an aromatic diamine component containing no oxygen atom in a molecule thereof and containing an aromatic diamine in which two carbon-nitrogen bond axes derived from amino groups are positioned on the same straight line and which contains no oxygen atom in a molecule thereof and an aromatic diamine in which two carbon-nitrogen bond axes derived from amino groups are not positioned on the same straight line and which contains no oxygen atom in a molecule thereof, and (C) a terminal capping agent having a phenylethynyl group.

Patent Literature 3 discloses an amic acid oligomer having a terminal(s) capped with 4-(2-phenylethynyl)phthalic anhydride and a method for producing the amic acid oligomer, and indicates that the amic acid oligomer can serve as a precursor of, for example, the imide oligomer disclosed in Patent Literature 1.

### CITATION LIST

### Patent Literature

### [Patent Literature 1]

International Publication No. WO 2010/027020

### [Patent Literature 2]

International Publication No. WO 2013/141132

### [Patent Literature 3]

International Publication No. WO 2020/072639

### SUMMARY OF INVENTION

### Technical Problem

The cured product disclosed in each of Patent Literatures 1 and 2 has excellent thermal characteristics and excellent mechanical characteristics. However, high-boiling-point N-methyl-2-pyrrolidone (NMP, boiling point: 204° C.) is used as a solvent for polymerization of a polyimide of the cured product and as a solvent for a varnish, and NMP is known to have high toxicity. Further, there is the following problem: In a process for producing a thick molded body or fiber composite material from a varnish, a solvent for the varnish has a high boiling point and thus is difficult to remove.

Patent Literature 3 solves a problem accompanying use of the high-boiling-point solvent disclosed in Patent Literature 1. In Patent Literature 3, for example, 2-methoxyethanol (boiling point: 125° C.) is used to produce a solution of an amic acid oligomer having a terminal(s) capped with 4-(2-phenylethynyl)phthalic anhydride, then a powder of the amic acid oligomer is isolated, and thereafter an imide oligomer is produced by an imidization reaction of the amic acid oligomer. As a means for obtaining a powder from a solution of an amic acid oligomer, Patent Literature 3 discloses, for example, a method in which an amic acid oligomer solution is poured into an aluminum tray, a solvent is then removed, and thereafter an obtained solid is pulverized (pulverization method), and a method in which an amic acid oligomer solution is poured into a solvent in which an amic acid oligomer cannot be dissolved (poor solvent) to precipitate a powder (reprecipitation method).

An aspect of the present invention has an object to achieve a novel method for producing an amic acid oligomer powder, the novel method being different from a pulverization method and a reprecipitation method.

### Solution to Problem

In order to attain the object, a method for producing an amic acid oligomer powder according to an aspect of the present invention includes a step of obtaining an amic acid oligomer powder by using a spray drying method to remove a solvent from a varnish of an amic acid oligomer, the amic acid oligomer powder containing a compound selected from the group consisting of general formulas (1), (2), and (3):

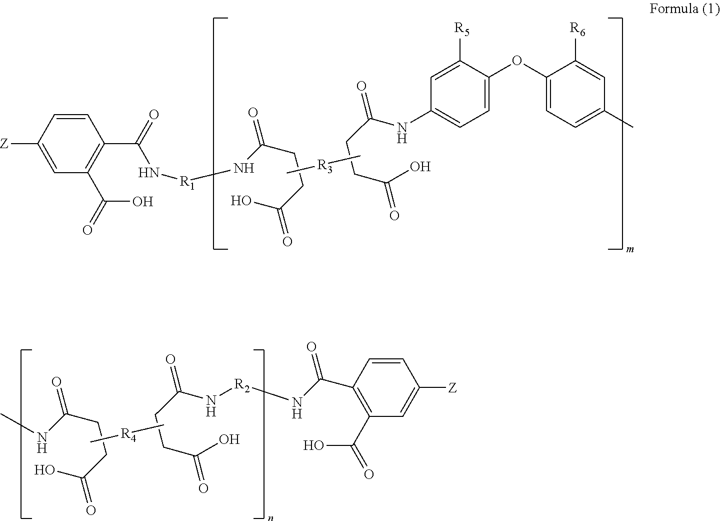

where R₁ and R₂ each represent a divalent aromatic diamine residue, R₃ and R₄ each represent a tetravalent aromatic carboxylic acid residue, two amide groups bonded to R₃ and R₄ are present in trans- or cis-positions, R₅ and R₆ each represent a hydrogen atom or a phenyl group, at least one of R₅ and R₆ is a phenyl group, m and n satisfy the following relationships: m≥1, n≥0, 1≤m+n≤20, and 0.05≤m/(m+n)≤1, repeating units formed by m and n may be arranged in a block or random manner, and Z represents a hydrogen atom or a 2-phenylethynyl group;

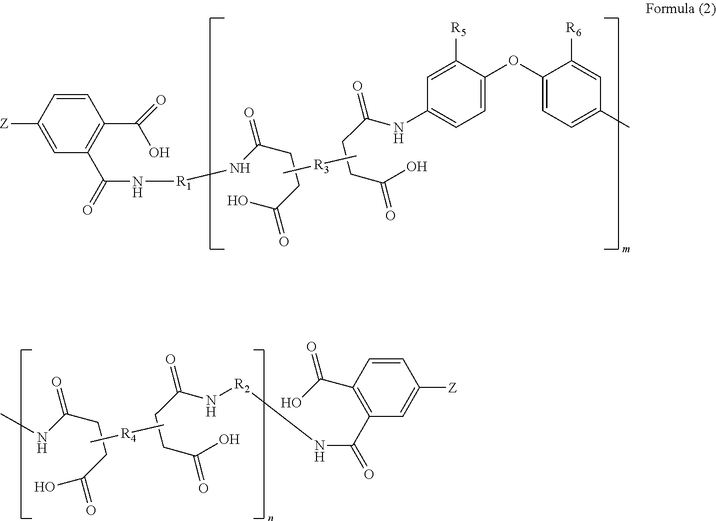

where R₁ and R₂ each represent a divalent aromatic diamine residue, R₃ and R₄ each represent a tetravalent aromatic carboxylic acid residue, two amide groups bonded to R₃ and R₄ are present in trans- or cis-positions, R₅ and R₆ each represent a hydrogen atom or a phenyl group, at least one of R₅ and R₆ is a phenyl group, m and n satisfy the following relationships: m≥1, n≥0, 1≤m+n≤20, and 0.05≤m/(m+n)≤1, repeating units formed by m and n may be arranged in a block or random manner, and Z represents a hydrogen atom or a 2-phenylethynyl group; and

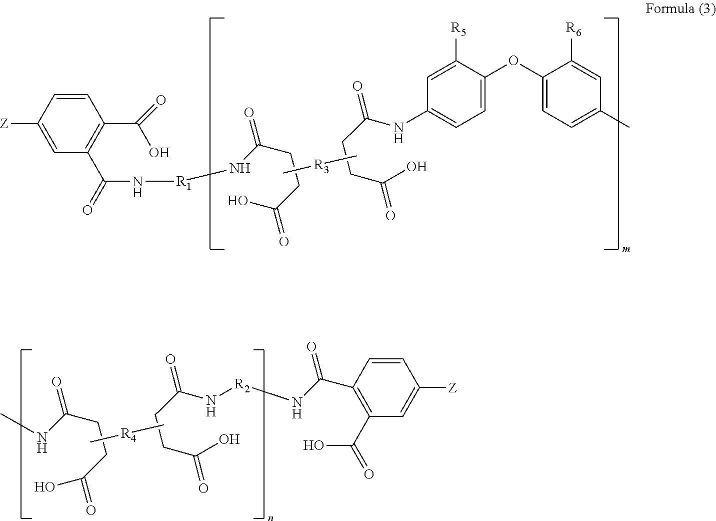

where R₁ and R₂ each represent a divalent aromatic diamine residue, R₃ and R₄ each represent a tetravalent aromatic carboxylic acid residue, two amide groups bonded to R₃ and R₄ are present in trans- or cis-positions, R₅ and R₆ each represent a hydrogen atom or a phenyl group, at least one of R₅ and R₆ is a phenyl group, m and n satisfy the following relationships: m≥1, n≥0, 1≤m+n≤20, and 0.05≤m/(m+n)≤1, repeating units formed by m and n may be arranged in a block or random manner, and Z represents a hydrogen atom or a 2-phenylethynyl group.

### Advantageous Effects of Invention

An aspect of the present invention makes it possible to provide a novel method for producing an amic acid oligomer powder, the novel method being different from a pulverization method and a reprecipitation method.

### BRIEF DESCRIPTION OF DRAWINGS

FIG. 1 is a diagram showing a result of SEM observation of an amic acid oligomer powder obtained in Example 6.

FIG. 2 is a diagram showing a result of SEM observation of the imide oligomer powder obtained in Example 6.

FIG. 3 is a diagram showing a result of SEM observation of an imide oligomer powder obtained in Comparative Example 2.

FIG. 4 is a diagram showing a result of SEM observation of an amic acid oligomer powder obtained in Comparative Example 3.

FIG. 5 is a diagram showing a result of SEM observation of the imide oligomer powder obtained in Comparative Example 3.

### DESCRIPTION OF EMBODIMENTS

The following description will discuss an embodiment of the present invention in detail. An embodiment of the present invention relates to an amic acid oligomer powder having a specific composition, a varnish, an imide oligomer, a cured product, and a composite material. In the present specification, the term “varnish” means a product obtained by dissolving an amic acid oligomer in a solvent, and is also referred to as an amic acid oligomer solution. In the present specification, the term “imide oligomer” means a product obtained by heating and dehydrating an amic acid oligomer. In the present specification, the term “cured product” means a product obtained by curing an amic acid oligomer or a varnish. In the present specification, the term “composite material” means a fiber-reinforced composite material. An embodiment of the present invention also relates to a film that is obtained from an amic acid oligomer, a varnish, or an imide oligomer. An embodiment of the present invention further relates to a prepreg or a semipreg obtained by heat-fusing or impregnating reinforcement fibers with an amic acid oligomer, a varnish, or an imide oligomer.

In the present specification, the terms “granular material” and “powder” are used interchangeably.

### [1. Amic Acid Oligomer]

In the present specification, the term “amic acid oligomer” is used synonymously with the “terminally modified amic acid oligomer” unless otherwise specified.

It is preferable that an amic acid oligomer according to an embodiment of the present invention be obtained by reacting (A) an aromatic tetracarboxylic acid component, (B) an aromatic diamine component, and that (C) a terminal capping agent, and the component (C) contain not less than 50 mol % and not more than 100 mol % of (c1) a compound containing a phenylethynyl group and not less than 0 mol % and less than 50 mol % of (c2) a compound containing no carbon-carbon unsaturated bond capable of an addition reaction, relative to the total amount of the component (C). In the present specification, an amic acid oligomer obtained by reacting (A) an aromatic tetracarboxylic acid component, (B) an aromatic diamine component, and (C) a terminal capping agent means an amic acid oligomer containing a monomer unit derived from the aromatic tetracarboxylic acid component (A), a monomer unit derived from the aromatic diamine component (B), and a monomer unit derived from the terminal capping agent (C).

In the present specification, the aromatic tetracarboxylic acid component (A) is intended to encompass acid dianhydrides and acid derivatives (such as esters and salts) of aromatic tetracarboxylic acid components. An aromatic tetracarboxylic acid component that is referred to as “ . . . compound” is similarly intended to encompass acid dianhydrides and acid derivatives (such as esters and salts). All aromatic tetracarboxylic acid components are preferably acid dianhydrides of aromatic tetracarboxylic acid components.

In the present specification, the phrase “a powder is deposited on reinforcement fibers” means that a certain amount of powder is present on a surface of the reinforcement fibers. In other words, the phrase does not mean up or down in the general sense (for example, sky or ground), and does not mean only that a powder is piled on an upper surface of a bundle of reinforcement fibers. That is, a state in which a powder enters a gap between individual reinforcement fibers and the powder and the fibers are mixed together is also included in “deposition.” A state in which a powder is present on a lower surface (lower surface in the direction of gravity) of a bundle of reinforcement fibers is also included in “deposition.” A form of the reinforcement fibers is exemplified by but not limited to a form in which fiber bundles are aligned unidirectionally and a woven-fabric form.

In some aspects, an aromatic diamine residue in general formula (1), (2), or (3) is an aromatic organic group present between two amino groups in an aromatic diamine. A tetravalent aromatic carboxylic acid residue in general formula (1), (2), or (3), that is, an aromatic tetracarboxylic acid residue, is an aromatic organic group which is present while being surrounded by four carbonyl groups of an aromatic tetracarboxylic acid. The aromatic organic group is an organic group containing an aromatic ring. The aromatic organic group is preferably an organic group having 4 to 30 carbon atoms, more preferably an organic group having 4 to 18 carbon atoms, and still more preferably an organic group having 4 to 12 carbon atoms. Further, the aromatic organic group is preferably a hydrocarbon group having 6 to 30 carbon atoms, more preferably a hydrocarbon group having 6 to 18 carbon atoms, and still more preferably a hydrocarbon group having 6 to 12 carbon atoms.

In some aspects, the aromatic tetracarboxylic acid is selected from 1,2,4,5-benzenetetracarboxylic acid, 3,3′,4,4′-biphenyltetracarboxylic acid, bis(3,4-carboxyphenyl) ether, and a combination of at least two thereof. In particular, the aromatic tetracarboxylic acid is more preferably 1,2,4,5-benzenetetracarboxylic dianhydride, 3,3′,4,4′-biphenyltetracarboxylic dianhydride, or bis(3,4-carboxyphenyl) ether dianhydride.

In one aspect, one or more tetracarboxylic dianhydrides, an aromatic diamine containing 2-phenyl-4,4′-diaminodiphenyl ether, and 4-(2-phenylethynyl)phthalic anhydride are used, in the presence or absence of an organic solvent in such amounts that the total amount of dicarboxylic acid groups and the total amount of primary amino groups are substantially the same, to synthesize an amic acid oligomer and an imide oligomer each having an unsaturated terminal group. Thus, in formula (1), (2), or (3), R₃ and R₄ are each independently selected from groups derived from the above various tetracarboxylic acids, and may be the same as or different from each other. In a case where m>1 and n>1 are satisfied, groups R₃ and R₄ may be the same as or different from each other. R₅ and R₆ each independently represent a hydrogen atom or a phenyl group, and at least one of R₅ and R₆ is a phenyl group. The imide oligomer has an imide bond in the main chain thereof, and the amic acid oligomer has an amide bond in the main chain thereof. Preferably, the amic acid oligomer and the imide oligomer have, at one terminal or two terminals (preferably two terminals) thereof, a polymerizable unsaturated terminal group derived from 4-(2-phenylethynyl)phthalic anhydride, satisfy a relationship of 1≤m+n≤20, and are solid (in powder form) at normal temperature (23° C.)

Generally, hydrolysis of a polyamic acid is likely to occur in a polyamic acid varnish due to moisture contained in a solution and moisture present in a container. In order to prevent or reduce such a hydrolysis reaction, especially long-term storage of a solution is carried out in a frozen state. After a suspension containing an amic acid oligomer in lump or powdered form is obtained by pouring, into a poor solvent such as water or alcohol, or in a non-solvent or the like, a solution containing the amic acid oligomer, and carrying out stirring, the amic acid oligomer can be isolated as a solid composition by an operation such as filtration. However, during such a process, moisture contained in a suspension solution and moisture absorption are likely to cause part of the amic acid oligomer to have a reduced molecular weight or be converted into a monomer due to a reverse reaction caused by hydrolysis. In particular, an acid dianhydride component is converted into a tetracarboxylic acid component by hydrolysis and cannot form an amic acid oligomer again. Thus, even by heating an amic acid oligomer obtained by a conventional method, it is difficult to form a desired imide oligomer in which imidization has been completely completed, and it is likely to cause a reduction in heat resistance.

Since the amic acid oligomer according to an embodiment of the present invention is in powder form rather than film form, thread form, or lump form, in a case where an imidization reaction by heating is carried out, the amic acid oligomer can be heated uniformly due to its large surface area, and an imide oligomer powder can be produced efficiently. Thus, a laminate that has been molded with use of a prepreg which is obtained with use of the imide oligomer powder is, in many cases, a composite material having stable mechanical strength. Furthermore, carrying out heating after uniformly depositing or spraying such a powder on carbon fibers enables efficient production of a dry prepreg of an imide oligomer. Thus, a laminate that has been molded with use of the prepreg is, in many cases, a composite material having stable mechanical strength. Moreover, since melting of an imide oligomer powder (particles), the shape of which is maintained, occurs uniformly in a narrow temperature range, a laminate that has been molded with use of a prepreg of the imide oligomer powder is, in many cases, a composite material having stable mechanical strength.

The following description compares a conventional method for producing an amic acid oligomer powder and a method for producing an amic acid oligomer powder with use of a spray drying method according to an embodiment of the present invention.

In a “reprecipitation method” in which an amic acid oligomer solution is poured into a poor solvent to obtain a powder and a “pulverization method” in which a powder is obtained by pulverizing a lump that is obtained by evaporating a solvent from an amic acid oligomer solution, a powder in a porous state or a foamed state is generally likely to be obtained. In contrast, in a granular resin material containing an amic acid oligomer obtained by the spray drying method according to an embodiment of the present invention, a spherical granular material having a hollow interior and a granular material in a state in which the spherical granular material is broken tend to be obtained. The spherical granular material and the granular material in a state in which the spherical granular material is broken are each hereinafter also referred to as a shell-derived granular material.

After a granular resin material in a porous state or a foamed state is obtained by the reprecipitation method or the pulverization method, it is sometimes not easy to remove, under high-temperature or vacuum conditions, a solvent contained inside the granular resin material. A solvent in a granular material in a porous state or a foamed state (including a solvent that is present while being absorbed on inner walls of porous pores or foam bubbles) is generally difficult to volatilize. Thus, the solvent tends to remain in the granular material, and a resin molded body tends not to exhibit desired thermal characteristics or mechanical characteristics. In contrast, in a shell-derived granular material, a solvent can be removed efficiently. Furthermore, in a shell-derived granular material of an amic acid oligomer, water by-produced during an imidization reaction is likely to volatilize. Thus, the imidization reaction proceeds more efficiently. Moreover, a shell-derived granular material has excellent flowability (slidability), and thus can be said to have excellent processability.

An amic acid oligomer obtained by the “pulverization method” is generally a relatively large lump. Thus, it is necessary to pulverize the lump in order to obtain a powder. A production method according to an embodiment of the present invention is also excellent in that no pulverization step is required. Further, a case where a lump is pulverized requires a step of classifying a powdery substance obtained by pulverization. The production method according to an embodiment of the present invention is also excellent in that no classification step is required.

The method for producing an amic acid oligomer powder with use of the spray drying method according to an embodiment of the present invention is superior to the reprecipitation method in the following points: (1) since a spherical granular material is obtained, a powder has high flowability (slidability) and is easily uniformly fed to and deposited on a surface during prepreg production; and (2) steps of precipitation and subsequent drying of the powder can be omitted.

### <Aromatic Tetracarboxylic Acid Component (A)>

The aromatic tetracarboxylic acid component (A) for obtaining an amic acid oligomer and an imide oligomer according to an embodiment of the present invention preferably contains (a1) a 1,2,4,5-benzenetetracarboxylic acid compound and (a2) a 3,3′,4,4′-biphenyltetracarboxylic acid compound in a molar ratio ranging from 100/0 to 20/80. In a case where the aromatic tetracarboxylic acid component (A) does not contain these compounds, a cured product to be obtained sometimes has an insufficient glass transition temperature (Tg) and insufficient thermal oxidative stability (TOS).

In the following description, the glass transition temperature is sometimes simply referred to as “Tg.” In the present specification, the glass transition temperature (Tg) refers to that measured by a method disclosed in Examples described later. Excellent hydrolysis stability means resistance that prevents a powder which is obtained from a varnish of the amic acid oligomer according to an embodiment of the present invention from being decomposed due to, for example, moisture in the surrounding environment and moisture absorption and that further prevents the powder from, for example, having a reduced Tg due to denaturation.

The 1,2,4,5-benzenetetracarboxylic acid compound (a1) includes 1,2,4,5-benzenetetracarboxylic acid, 1,2,4,5-benzenetetracarboxylic dianhydride (PMDA), and acid derivatives (such as esters and salts) of 1,2,4,5-benzenetetracarboxylic acid.

Similarly, the 3,3′,4,4′-biphenyltetracarboxylic acid compound (a2) includes 3,3′,4,4′-biphenyltetracarboxylic acid, 3,3′,4,4′-biphenyltetracarboxylic dianhydride (s-BPDA), and acid derivatives (such as esters and salts) of 3,3′,4,4′-biphenyltetracarboxylic acid.

A content of the 1,2,4,5-benzenetetracarboxylic acid compound in the aromatic tetracarboxylic acid component is preferably not less than 20 mol %, more preferably not less than 40 mol %, and still more preferably not less than 60 mol %. In a case where the content of the 1,2,4,5-benzenetetracarboxylic acid compound is lower than 30 mol %, a cured product that is obtained from the amic acid oligomer according to an embodiment of the present invention sometimes has a low glass transition temperature (Tg).

The aromatic tetracarboxylic acid component can contain the 1,2,4,5-benzenetetracarboxylic acid compound and the 3,3′,4,4′-biphenyltetracarboxylic acid compound in a molar ratio ranging from 100/0 to 20/80. Note, however, that, in a case where a cured product having a high glass transition temperature (Tg) is to be obtained, the molar ratio of the 1,2,4,5-benzenetetracarboxylic acid compound to the 3,3′,4,4′-biphenyltetracarboxylic acid compound is preferably in a range of 100/0 to 40/60, and more preferably in a range of 100/0 to 60/40.

In a case where the 1,2,4,5-benzenetetracarboxylic acid compound and the 3,3′,4,4′-biphenyltetracarboxylic acid compound are used in combination as the aromatic tetracarboxylic acid component, a total content of the 1,2,4,5-benzenetetracarboxylic acid compound and the 3,3′,4,4′-biphenyltetracarboxylic acid compound in the aromatic tetracarboxylic acid component is preferably not less than 50 mol %, more preferably not less than 70 mol %, and still more preferably not less than 90 mol %. As a result of causing the total content of the 1,2,4,5-benzenetetracarboxylic acid compound and the 3,3′,4,4′-biphenyltetracarboxylic acid compound to be in the above range, a cured product of an imide oligomer which cured product is obtained from the amic acid oligomer according to an embodiment of the present invention exhibits a high glass transition temperature (Tg).

As the aromatic tetracarboxylic acid component, which is the component (A) for obtaining the amic acid oligomer according to an embodiment of the present invention, the 1,2,4,5-benzenetetracarboxylic acid compound and the 3,3′,4,4′-biphenyltetracarboxylic acid compound can be contained. Note, however, that another aromatic tetracarboxylic acid component other than the 1,2,4,5-benzenetetracarboxylic acid compound and the 3,3′,4,4′-biphenyltetracarboxylic acid compound may be contained as long as an effect of an embodiment of the present invention is exhibited. Examples of the another aromatic tetracarboxylic acid component include a 3,3′,4,4′-benzophenonetetracarboxylic acid compound, a 2,3,3′,4′-benzophenonetetracarboxylic acid compound, a 2,3,3′,4′-biphenyltetracarboxylic acid compound, a 2,2′,3,3′-biphenyltetracarboxylic acid compound, a 4,4′-sulfonyldiphthalic acid compound, a 4,4′-thiodiphthalic acid compound, a 4,4′-oxydiphthalic acid compound, a 3,4′-oxydiphthalic acid compound, a 4,4′-isopropylidenediphthalic acid compound, a 4,4′-(hexafluoroisopropylidene)diphthalic acid compound, a 4,4′-[1,4-phenylenebis(oxy)]diphthalic acid compound, a 4,4′-[1,3-phenylenebis(oxy)]diphthalic acid compound, a 1,4,5,8-naphthalenetetracarboxylic acid compound, a 2,3,6,7-naphthalenetetracarboxylic acid compound, a 2,3,6,7-anthracenetetracarboxylic acid compound, a 3,4,9,10-perylenetetracarboxylic acid compound, a 1,2,3,4-benzenetetracarboxylic acid compound, and a 9,9-bis(3,4-dicarboxyphenyl)fluorene compound, and these may be used alone or in combination of two or more.

### <Aromatic Diamine Component (B)>

From the viewpoints of solubility of an amic acid oligomer in a solvent, and Tg and mechanical properties of a cured product, the aromatic diamine component for obtaining the amic acid oligomer according to an embodiment of the present invention preferably contains, as an essential component, a component having an asymmetrical and non-planar structure, and may contain a component having a symmetrical and planar structure.

Of the aromatic diamine component for obtaining the amic acid oligomer according to an embodiment of the present invention, the component having an asymmetrical and non-planar structure preferably contains 2-phenyl-4,4′-diaminodiphenyl ether. Containing 2-phenyl-4,4′-diaminodiphenyl ether allows the imide oligomer according to an embodiment of the present invention to exhibit excellent moldability and excellent solubility in a solvent. In the present specification, moldability is a concept encompassing melt flowability at a high temperature and having low melt viscosity.

As the aromatic diamine component for obtaining the amic acid oligomer according to an embodiment of the present invention, another aromatic diamine component (b3) other than 2-phenyl-4,4′-diaminodiphenyl ether may be contained as long as the effect of an embodiment of the present invention is exhibited. Examples of the another aromatic diamine component (b3) include 1,4-diaminobenzene, 1,2-diaminobenzene, 2,6-diethyl-1,3-diaminobenzene, 4,6-diethyl-2-methyl-1,3-diaminobenzene, 2,5-diaminotoluene, 2,4-diaminotoluene, 2,6-diaminotoluene, 3,3′-diaminodiphenylmethane, 4,4′-diaminodiphenylmethane, bis(2,6-diethyl-4-aminophenyl)methane, 4,4′-methylene-bis(2,6-diethylaniline), bis(2-ethyl-6-methyl-4-aminophenyl)methane, 4,4′-methylene-bis(2-ethyl-6-methylaniline), 2,2′-bis(trifluoromethyl)benzidine, 2,2′-dimethylbenzidine, 3,3′-dimethylbenzidine, 3,3′,5,5′-tetramethylbenzidine, 4,4-diaminooctafluorobiphenyl, 2,2-bis(3-aminophenyl)propane, 2,2-bis(4-aminophenyl)propane, 4,4′-diaminodiphenyl ether (4,4′-ODA), 3,3′-diaminobenzophenone, 4,4′-diaminobenzophenone, 9,9-bis(4-aminophenyl)fluorene, 9,9-bis(4-(4-aminophenoxy)phenyl)fluorene, 1,3-bis(4-aminophenoxy)benzene, 1,3-bis(3-aminophenoxy)benzene, 1,4-bis(4-aminophenoxy)benzene, 1,4-bis(3-aminophenoxy)benzene, 2,2-bis[4-(4-aminophenoxy)phenyl]hexafluoropropane, 2,2-bis[4-(3-aminophenoxy)phenyl]hexafluoropropane, 4,4′-bis(4-aminophenoxy)biphenyl, and 4,4′-bis(3-aminophenoxy)biphenyl, and these may be used alone or in combination of two or more.

Among these, the another aromatic diamine component is preferably 9,9-bis(4-aminophenyl)fluorene. In particular, in a case where a cured product having a high glass transition temperature (Tg) is to be obtained, 9,9-bis(4-aminophenyl)fluorene is preferably used in an amount of not less than 10 mol %.

### <Terminal Capping Agent (C)>

The terminal capping agent, which is the component (C) for obtaining the amic acid oligomer according to an embodiment of the present invention, preferably contains not less than 50 mol % and not more than 100 mol % of (c1) a compound containing a phenylethynyl group and optionally not less than 0 mol % and less than 50 mol % of (c2) a compound containing no carbon-carbon unsaturated bond capable of an addition reaction, relative to a total amount of the component (C). Further, in a case where a terminal to be capped is an amine terminal derived from the aromatic diamine component (B), the terminal capping agent is preferably a carboxylic acid compound that reacts with the amine terminal to form an imide group. In order to obtain an amic acid oligomer having an amine terminal, the aromatic diamine component is preferably used in a stoichiometrically excessive molar amount relative to the aromatic tetracarboxylic acid component. The aromatic diamine component is used in a molar amount in a range of preferably not less than 1.01 times and not more than 2.00 times, and more preferably not less than 1.02 times and not more than 2.00 times as large as a molar amount of the aromatic tetracarboxylic acid component. In the present specification, the component (C) that is referred to as “ . . . compound” is intended to encompass acid anhydrides and acid derivatives (such as esters and salts).

Further, a molar amount of the component (C) is preferably not less than 1.7 times and not more than 5.0 times, more preferably not less than 1.9 times and not more than 4.0 times, and still more preferably not less than 1.95 times and not more than 2.0 times as large as a molar amount corresponding to a difference between the molar amount of the aromatic diamine component and the molar amount of the aromatic tetracarboxylic acid component. In a case where the molar amount of the component (C) is smaller than the above range, thermal oxidative stability (TOS) is sometimes insufficient due to a large amount of uncapped amine terminals remaining in the amic acid oligomer. In a case where the molar amount of the component (C) is larger than the above range, a large amount of the unreacted component (C) remains in the amic acid oligomer. This sometimes causes defects (voids) due to volatilization of the remaining component (C) in a large amount during heat molding of a cured product of the amic acid oligomer or during heat molding of a fiber-reinforced composite material.

As the compound (c1), a 4-(2-phenylethynyl)phthalic acid compound is preferably used. The 4-(2-phenylethynyl)phthalic acid compound includes 4-(2-phenylethynyl) phthalic acid, 4-(2-phenylethynyl)phthalic anhydride (PEPA), and acid derivatives (such as esters and salts) of 4-(2-phenylethynyl)phthalic acid. Using the 4-(2-phenylethynyl)phthalic acid compound allows a cured product that is obtained from the amic acid oligomer according to an embodiment of the present invention to exhibit excellent heat resistance and excellent mechanical characteristics.

A content of the 4-(2-phenylethynyl)phthalic acid compound as the compound (c1) in the component (C) is preferably more than 50 mol % and not more than 100 mol %, more preferably not less than 60 mol % and not more than 100 mol %, and still more preferably not less than 70 mol % and not more than 100 mol %. In a case where the content of the 4-(2-phenylethynyl)phthalic acid compound is low, toughness of a cured product that is obtained from the imide oligomer according to an embodiment of the present invention is sometimes insufficient.

As the compound (c2), a 1,2-benzenedicarboxylic acid compound is preferably used. The 1,2-benzenedicarboxylic acid compound includes 1,2-benzenedicarboxylic acid, 1,2-benzenedicarboxylic anhydride (phthalic anhydride), and acid derivatives (such as esters or salts) of 1,2-benzenedicarboxylic acid. Using the 1,2-benzenedicarboxylic acid compound allows a cured product that is obtained from the imide oligomer according to an embodiment of the present invention to exhibit excellent thermal oxidative stability (TOS) at a high temperature.

A content of the 1,2-benzenedicarboxylic acid compound as the compound (c2) in the component (C) is preferably not less than 0 mol % and less than 50 mol %, more preferably not less than 0 mol % and not more than 40 mol %, and still more preferably not less than 0 mol % and not more than 30 mol %. In an embodiment of the present invention, the 1,2-benzenedicarboxylic acid compound is not essential but functions to improve thermal oxidative stability (TOS) of a cured product that is obtained from an amic acid oligomer. In contrast, in a case where the content of the 1,2-benzenedicarboxylic acid compound is high, toughness of a cured product to be obtained is sometimes insufficient.

It is particularly preferable that the compound (c1) contained in the component (C) be the 4-(2-phenylethynyl)phthalic acid compound and the compound (c2) contained in the component (C) be the 1,2-benzenedicarboxylic acid compound.

A degree of polymerization m+n of the amic acid oligomer according to an embodiment of the present invention (the number of repeating structural units that are generated by reaction between the aromatic tetracarboxylic acid component and the aromatic diamine component) is preferably not more than 100, more preferably not more than 50, still more preferably not more than 30, particularly preferably not more than 20, and most preferably not more than 10. In a case where the degree of polymerization is in the above range, the amic acid oligomer according to an embodiment of the present invention has excellent moldability and excellent solubility in a solvent.

### <Others>

A molecular weight of the amic acid oligomer according to an embodiment of the present invention can be regulated by adjusting, as appropriate, a ratio of the molar amount of the aromatic tetracarboxylic acid component to the molar amount of the aromatic diamine component. The molar amount of the aromatic diamine component relative to the molar amount of the aromatic tetracarboxylic acid component may be a stoichiometrically excessive amount, an equivalent amount, or an insufficient amount, but a stoichiometrically excessive amount is preferable. The aromatic diamine component is used in a molar amount in a range of preferably not less than 1.01 times and not more than 2.00 times (corresponding to an average degree of polymerization m+n of an amic acid oligomer to be obtained of not less than 1 and not more than 100), and more preferably not less than 1.02 times and not more than 2.00 times (corresponding to an average degree of polymerization m+n of an amic acid oligomer to be obtained of not less than 1 and not more than 50) as large as the molar amount of the aromatic tetracarboxylic acid component. In a case where the molar amount of the aromatic diamine component is in the above range, the amic acid oligomer according to an embodiment of the present invention has excellent moldability and excellent solubility in a solvent. The degree of polymerization m+n of the amic acid oligomer represents the number of repeating structural units generated by reaction between the aromatic tetracarboxylic acid component and the aromatic diamine component. In a case where the amic acid oligomer is used for an application that requires higher mechanical strength, 0.05≤m/(m+n)≤1 is preferably satisfied, 0.75≤m/(m+n)<1 is more preferably satisfied, 0.90≤m/(m+n)<1 is still more preferably satisfied, and 0.90≤m/(m+n)<0.95 is most preferably satisfied.

The amic acid oligomer according to an embodiment of the present invention may be a mixture of amic acid oligomers having different molecular weights. The amic acid oligomer according to an embodiment of the present invention may be mixed with another amic acid oligomer, a polyimide, a soluble polyimide, or a thermoplastic polyimide. The amic acid oligomer, the polyimide, the soluble polyimide, or the thermoplastic polyimide may specifically be a commercially available product and is not particularly limited in type, etc.

The amic acid oligomer according to an embodiment of the present invention is preferably soluble in an amount of not less than 20% by weight in a solvent at room temperature. Examples of the solvent include a mixed solvent of an alcohol-based solvent and an ether-based solvent, a single solvent of a hydroxy ether-based solvent, a mixed solvent of an alcohol-based solvent and a hydroxy ether-based solvent, a mixed solvent of an ether-based solvent and a hydroxy ether-based solvent, and a mixed solvent of an alcohol-based solvent, an ether-based solvent, and a hydroxy ether-based solvent. Among these solvents, a solvent having a boiling point (in a mixed solvent, a boiling point of each single solvent) of not higher than 150° C. is preferable, and a solvent having a boiling point of not higher than 130° C. is more preferable. In a case where the boiling point exceeds 150° C., it is difficult to remove the solvent, and the solvent remaining in a cured product may cause a deterioration in thermal properties and in mechanical properties and a reduction in safety for a human body during handling. Thus, the case where the boiling point exceeds 150° C. is not preferable.

A solvent that has too low ability to dissolve an amic acid oligomer cannot provide an amic acid oligomer solution having an appropriate concentration. Thus, it is necessary to select a solvent that has appropriate ability to dissolve the amic acid oligomer. It is more preferable that an alcohol-based solvent, an ether-based solvent, and a hydroxy ether-based solvent each have two or more oxygen atoms per molecule. This is because such a solvent has excellent solubility.

An alcohol-based solvent and a hydroxy ether-based solvent have an advantage in that a hydroxyl group possessed by a molecule stabilizes, for example, a radical which may be formed from an ether-based solvent during autoxidation by oxygen, and thus a peroxide is less likely to be generated during obtainment of an amic acid oligomer. That is, an alcohol-based solvent and a hydroxy ether-based solvent also function as stabilizers for an ether-based solvent. Unlike an ether-based solvent, the hydroxy ether-based solvent has a function of self-stabilization even when used as a single solvent. However, in expectation of further stabilization, the hydroxy ether-based solvent may be used as a mixed solvent with an alcohol-based solvent.

Among the above-listed solvents (including mixed solvents), a single solvent of a hydroxy ether-based solvent and a mixed solvent of an ether-based solvent and a hydroxy ether-based solvent are more preferable. Among these solvents, a solvent having a boiling point (in a mixed solvent, a boiling point of each single solvent) of not higher than 150° C. is preferable, and a solvent having a boiling point of not higher than 130° C. is particularly preferable. In a case where the boiling point exceeds 150° C., it is difficult to remove the solvent, and the solvent remaining in a cured product may cause problems in physical properties and safety. Thus, the case where the boiling point exceeds 150° C. is sometimes not preferable.

A known technique related to a soluble polyamic acid can be applied to selection of these solvents.

Examples of the alcohol-based solvent include methanol (boiling point: 65° C.), ethanol (boiling point: 78° C.), 1-propanol (boiling point: 98° C.), and 2-propanol (boiling point: 82° C.).

Examples of the ether-based solvent include 1,3-dioxane (boiling point: 105° C.), 1,4-dioxane (boiling point: 101° C.), tetrahydrofuran (boiling point: 66° C.), 1,3-dioxolane (boiling point: 75° C.), and 1,2-dimethoxyethane (boiling point: 83° C.)

Examples of the hydroxy ether-based solvent include methoxymethanol (boiling point: 90° C. to 95° C.), ethoxymethanol (boiling point: 102° C.), 2-methoxyethanol (boiling point: 124° C.), 2-ethoxyethanol (boiling point: 135° C.), and 1-methoxy-2-propanol (boiling point: 119° C.).

### [2. Method for Producing Amic Acid Oligomer Varnish]

A method for producing an imide oligomer and an amic acid oligomer varnish according to an embodiment of the present invention is not particularly limited. Any method can be used to obtain the imide oligomer and the amic acid oligomer varnish, and one example thereof will be described below.

The amic acid oligomer according to an embodiment of the present invention is obtained by mixing and heating the aromatic tetracarboxylic acid component, the aromatic diamine component, and the terminal capping agent. For example, first, an aromatic tetracarboxylic dianhydride, an aromatic diamine, and 4-(2-phenylethynyl)phthalic anhydride and 1,2-benzenedicarboxylic anhydride (phthalic anhydride), each serving as the terminal capping agent, are used such that a total amount of acid anhydride groups of all components is substantially equal to a total amount of amino groups of all the components. These components are each reacted in a solvent at a temperature of not higher than approximately 100° C., and particularly not higher than 80° C. to generate an amic acid oligomer having an amide bond. As desired, the amic acid oligomer can also be partially or wholly dehydrated and cyclized by a method of adding a chemical imidization agent at not lower than approximately 0° C. and not higher than approximately 140° C. or a method of heating to a high temperature of not lower than 140° C. and not higher than 275° C. to obtain a mixture of some of imide oligomers or all the imide oligomers.

Examples of a particularly preferable method for producing the amic acid oligomer according to an embodiment of the present invention include the following method. First, after an aromatic diamine is uniformly dissolved in a solvent, an aromatic tetracarboxylic dianhydride is added to a resulting solution so as to be reacted at not lower than approximately 5° C. and not higher than approximately 60° C. and uniformly dissolved. Thereafter, 4-(2-phenylethynyl)phthalic anhydride and 1,2-benzenedicarboxylic anhydride (phthalic anhydride), each serving as the terminal capping agent, are further added to a resulting solution and reacted at not lower than approximately 5° C. and not higher than approximately 60° C., thereby generating the amic acid oligomer. Then, as desired, a resulting reaction solution is stirred at not lower than 140° C. and not higher than 275° C. for not less than 5 minutes and not more than 24 hours to cause an imidization reaction of the amic acid oligomer to generate a polyimide. If necessary, a polyimide can also be obtained by cooling the reaction solution to around room temperature. In the above reaction, all reaction steps or some of the reaction steps are preferably carried out in an atmosphere of an inert gas such as nitrogen gas or argon gas, or in vacuum.

Examples of the solvent include a mixed solvent of an alcohol-based solvent and an ether-based solvent, a single solvent of a hydroxy ether-based solvent, a mixed solvent of an alcohol-based solvent and a hydroxy ether-based solvent, a mixed solvent of an ether-based solvent and a hydroxy ether-based solvent, and a mixed solvent of an alcohol-based solvent, an ether-based solvent, and a hydroxy ether-based solvent. Among these solvents, a solvent having a boiling point (in a mixed solvent, a boiling point of each single solvent) of not higher than 150° C. is preferable, and a solvent having a boiling point of not higher than 130° C. is more preferable. In a case where the boiling point exceeds 150° C., it is difficult to remove the solvent, and the solvent remaining in a cured product may cause problems in physical properties and safety. Thus, the case where the boiling point exceeds 150° C. is sometimes not preferable. It is more preferable that an alcohol-based solvent, an ether-based solvent, and a hydroxy ether-based solvent each have two or more oxygen atoms per molecule. This is because such a solvent has excellent solubility. An alcohol-based solvent and a hydroxy ether-based solvent have an advantage in that a peroxide is less likely to be generated during obtainment of an amic acid oligomer. Thus, a solvent that is used to produce an amic acid oligomer preferably contains, as an essential solvent, at least one of an alcohol-based solvent and a hydroxy ether-based solvent.

A single solvent of a hydroxy ether-based solvent and a mixed solvent of an ether-based solvent and a hydroxy ether-based solvent are more preferable. Among these solvents, a solvent having a boiling point (in a mixed solvent, a boiling point of each single solvent) of not higher than 150° C. is preferable, and a solvent having a boiling point of not higher than 130° C. is particularly preferable. In a case where the boiling point exceeds 150° C., it is difficult to remove the solvent, and the solvent remaining in a cured product may cause problems in physical properties and safety. Thus, the case where the boiling point exceeds 150° C. is sometimes not preferable. It is more preferable that an ether-based solvent and a hydroxy ether-based solvent each have two or more oxygen atoms per molecule. This is because such a solvent has excellent solubility. A hydroxy ether-based solvent has an advantage in that a peroxide is less likely to be generated during obtainment of an amic acid oligomer. Thus, a solvent that is used to produce an amic acid oligomer preferably contains a hydroxy ether-based solvent as an essential solvent.

A known technique related to a soluble amic acid oligomer can be applied to selection of these solvents.

Specific examples of the alcohol-based solvent, the ether-based solvent, and the hydroxy ether-based solvent include the solvents listed in [1. Armic acid oligomer].

A varnish according to an embodiment of the present invention is obtained by dissolving the amic acid oligomer in a solvent. The varnish according to an embodiment of the present invention can be obtained by dissolving, in a solvent, the amic acid oligomer in powder form. Alternatively, a solution before powdering of the amic acid oligomer according to an embodiment of the present invention which amic acid oligomer is described in [2. Method for producing amic acid oligomer varnish] may be used as it is, or concentrated or diluted, as appropriate, to obtain a varnish as a solution composition of the amic acid oligomer.

As a solvent contained in the varnish, any of the solvents listed in [1. Amnic acid oligomer] can be used. Selection of a preferable solvent (including a mixed solvent) from among the solvents and a reason for the selection are the same as those described in [1. Amic acid oligomer].

### [3. Method for Producing Amic Acid Oligomer Powder]

A powder of the amic acid oligomer according to an embodiment of the present invention can be obtained by removing a solvent from the solution of the amic acid oligomer according to an embodiment of the present invention which solution has been obtained as described above, and can be used.

An amic acid oligomer powder according to an embodiment of the present invention can be obtained by removing a solvent from a varnish of an amic acid oligomer by a spray drying method. In an embodiment of the present invention, spray drying equipment specifications, conditions, and processes are not particularly limited.

A method for producing the amic acid oligomer powder according to an embodiment of the present invention includes a step of obtaining an amic acid oligomer powder by using a spray drying method to remove a solvent from a varnish of an amic acid oligomer, the amic acid oligomer powder containing a compound selected from the group consisting of general formulas (1), (2), and (3)

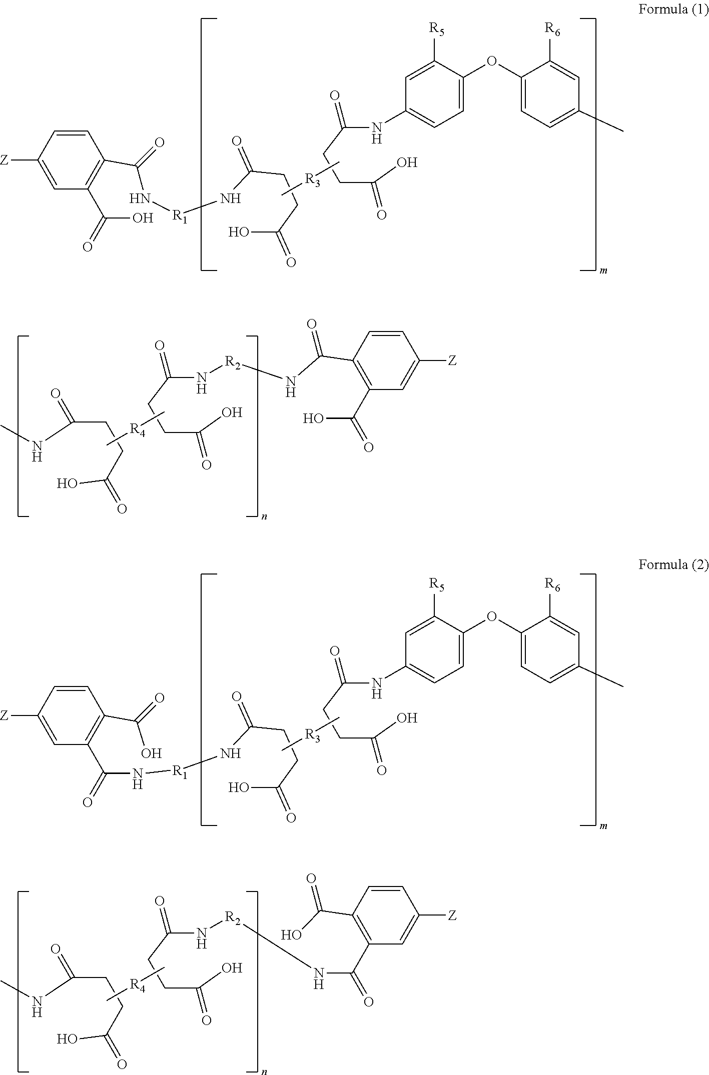

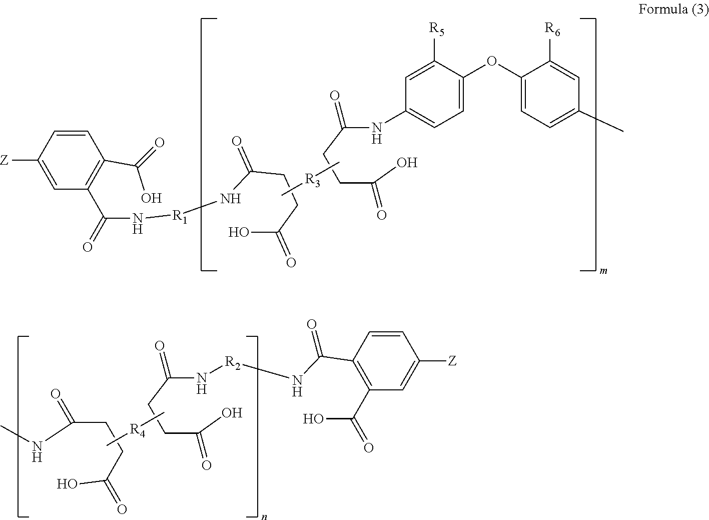

where R₁ and R₂ each represent a divalent aromatic diamine residue, R₃ and R₄ each represent a tetravalent aromatic carboxylic acid residue, two amide groups bonded to R₃ and R₄ are present in trans- or cis-positions, R₅ and R₆ each represent a hydrogen atom or a phenyl group, at least one of R₅ and R₆ is a phenyl group, m and n satisfy the following relationships: m≥1, n≥0, 1≤m+n≤20, and 0.05≤m/(m+n)≤1, repeating units formed by m and n may be arranged in a block or random manner, and Z represents a hydrogen atom or a 2-phenylethynyl group. An embodiment of the present invention also encompasses an amic acid oligomer powder that is obtained by the above production method.

The compound selected from the group consisting of the general formulas (1), (2), and (3) may be a compound selected from the group consisting of general formulas (4), (5), and (6):

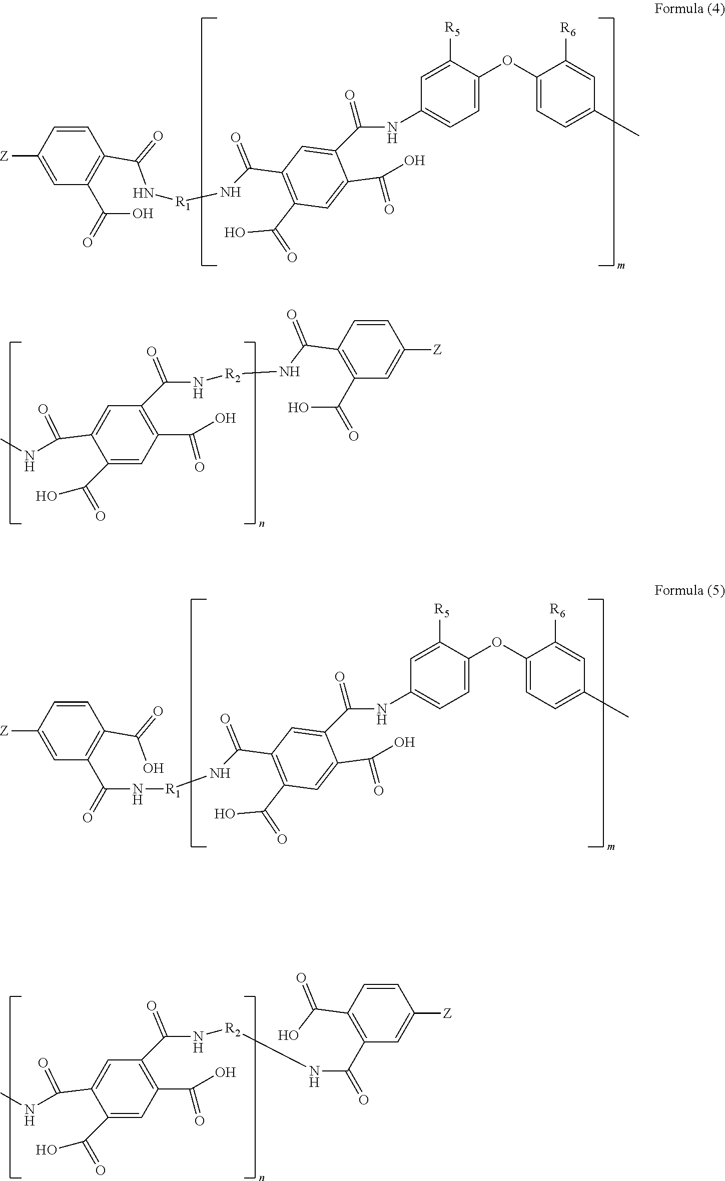

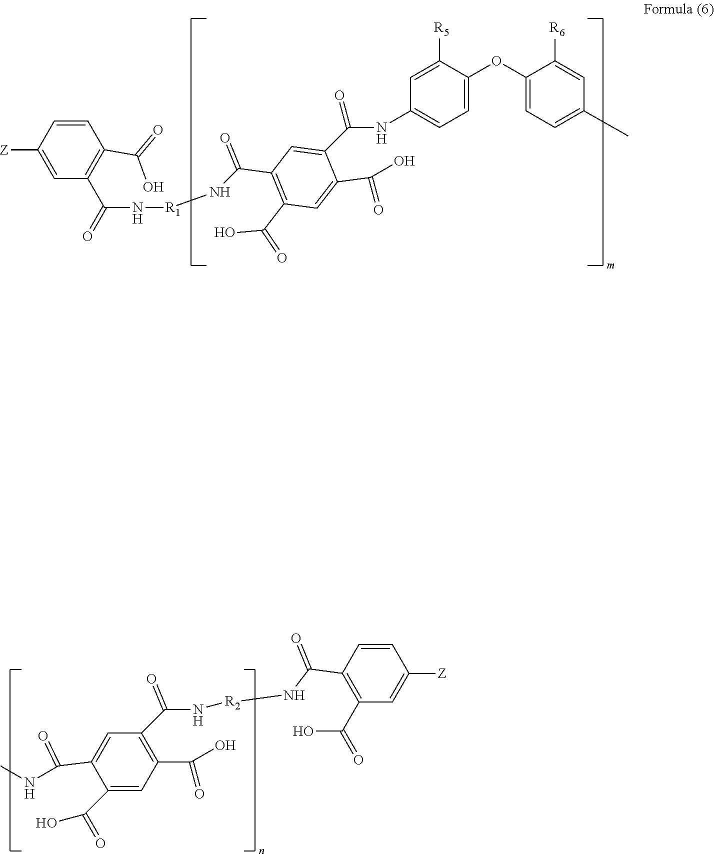

where R₁ and R₂ each represent a divalent aromatic diamine residue, two amide groups bonded to tetravalent benzene rings corresponding to R₃ and R₄ in formulas (1) to (3) are present in trans- or cis-positions, R₅ and R₆ each represent a hydrogen atom or a phenyl group, at least one of R₅ and R₆ is a phenyl group, m and n satisfy the following relationships: m≥1, n≥0, 1≤m+n≤20, and 0.05≤m/(m+n)≤1, repeating units formed by m and n may be arranged in a block or random manner, and Z represents a hydrogen atom or a 2-phenylethynyl group.

For example, the compound selected from the group consisting of general formulas (1), (2), and (3) may be a compound selected from the group consisting of general formulas (1A), (2A), and (3A). The compound selected from the group consisting of general formulas (1A), (2A), and (3A) may be a compound selected from the group consisting of general formulas (4A), (5A), and (6A)

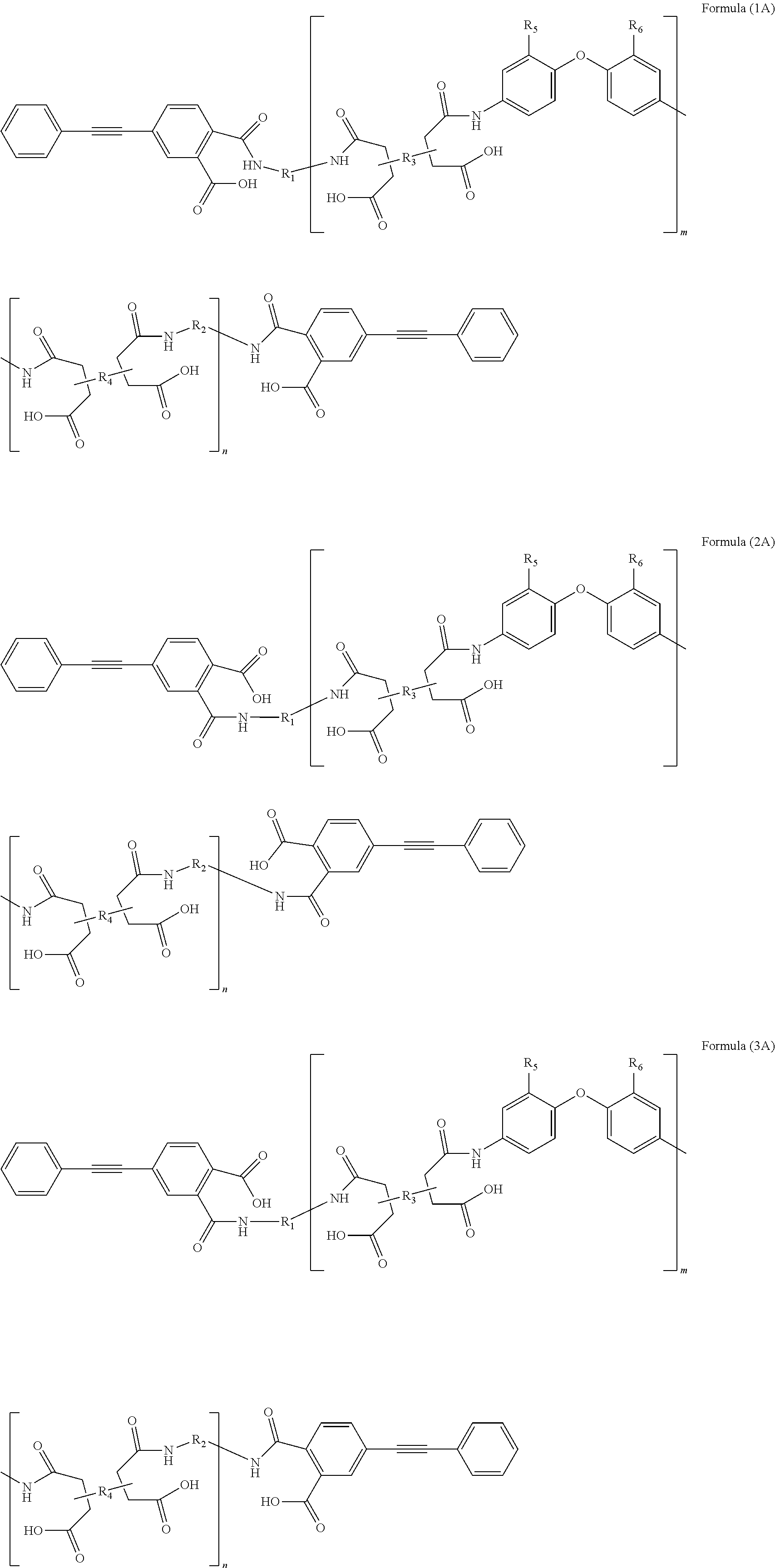

Definitions in formulas (1A) to (3A) are the same as definitions in formulas (1) to (3).

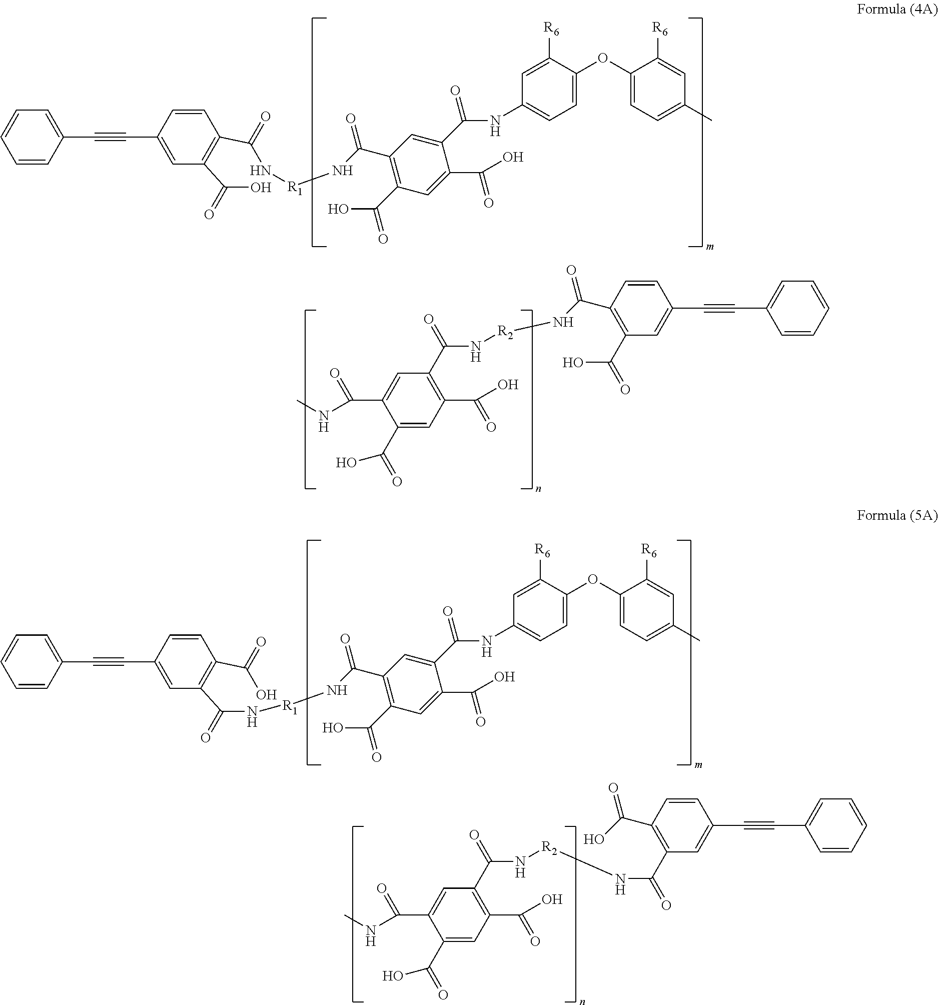

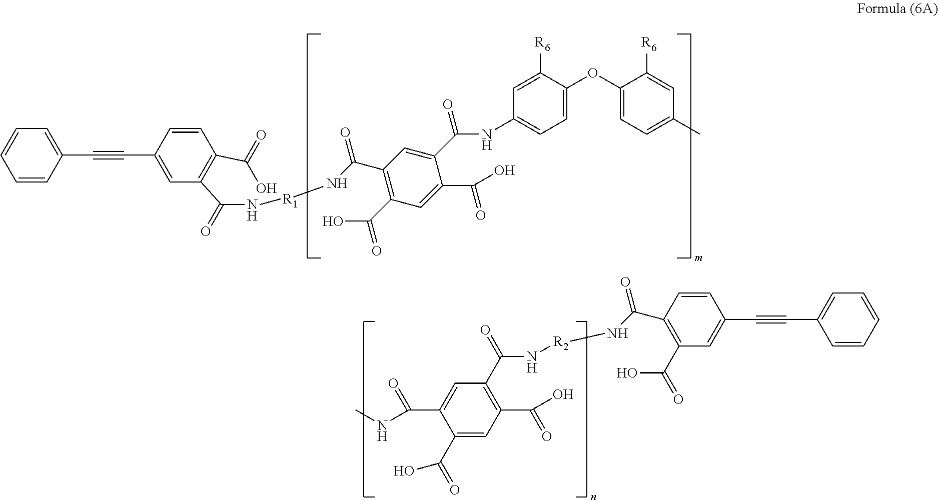

Definitions in formulas (4A) to (6A) are the same as definitions in formulas (4) to (6).

In the spray drying method, a sample solution is sprayed into high-temperature heated air and dried, and thus powders with a uniform shape can be produced. The spray drying method is often used for the purpose of mass production of powders. Thus, in the spray drying method, it is general that, in order to produce a large amount of granular material in a short time, a sample solution is fed to a spray dryer at a high rate, an inlet temperature of the spray dryer is made as high as possible, droplets are sprayed at a high speed, and drying is carried out in contact with hot air in a drying chamber or under vacuum. In ordinary spray drying, it is general that an evaporation rate of a solvent contained in sprayed droplets is extremely high, and most of obtained products have a hollow shape.

A solvent used in a varnish of an amic acid oligomer which varnish is to be fed to a spray dryer according to an embodiment of the present invention is not limited, and examples thereof include the solvents listed in [1. Amic acid oligomer].

A concentration of the varnish of the amic acid oligomer which varnish is to be fed to the spray dryer according to an embodiment of the present invention is, as a solid content concentration of the amic acid oligomer, preferably not less than 5% and not more than 80%, more preferably not less than 10% and not more than 60%, and still more preferably not less than 15% and not more than 45%. The solid content concentration may be not less than 10% and not more than 80%, or may be not less than 10% and not more than 50%.

A feed rate of the varnish of the amic acid oligomer which varnish is to be fed to the spray dryer according to an embodiment of the present invention is preferably not less than 10 g/min and not more than 900 g/min, more preferably not less than 15 g/min and not more than 700 g/min, and still more preferably not less than 20 g/min and not more than 500 g/min. The feed rate may be not less than 1 g/min and not more than 900 g/min, may be not less than 1 g/min and not more than 700 g/min, or may be not less than 1 g/min and not more than 500 g/min.

An inlet temperature of the spray dryer according to an embodiment of the present invention is ordinarily not lower than 30° C. and not higher than 280° C., preferably not lower than 35° C. and not higher than 270° C., more preferably not lower than 40° C. and not higher than 260° C., and still more preferably not lower than 40° C. and not higher than 250° C. The inlet temperature may be not lower than 30° C. and not higher than 180° C., may be not lower than 30° C. and not higher than 150° C., or may be not lower than 30° C. and not higher than 130° C.

A spraying method of the spray dryer according to an embodiment of the present invention is not particularly limited and is selected from, for example, a spray nozzle method and an atomizer method.

An internal temperature of a chamber of the spray dryer according to an embodiment of the present invention is preferably not lower than 30° C. and not higher than 180° C., more preferably not lower than 35° C. and not higher than 170° C., and still more preferably not lower than 40° C. and not higher than 150° C. The internal temperature of the chamber may be not lower than 30° C. and not higher than 170° C., or may be not lower than 30° C. and not higher than 120° C.

A shape of the amic acid oligomer powder according to an embodiment of the present invention which amic acid oligomer powder has been obtained by the spray drying method is not particularly limited and may be a spherical shape, a rectangular parallelepiped shape, or the like. Generally, an amic acid oligomer powder may have a shape that is in a hollow state in which air is present in an inner part of the amic acid oligomer powder, in a state in which the inner part is filled with a resin, or in a hollow state with a broken shell. However, the shape of the amic acid oligomer powder which is produced by the production method according to an embodiment of the present invention is preferably a shape of a shell-derived powder (shape of the foregoing shell-derived granular material). A range of a particle size of an obtained powder is preferably not less than 1 μm and not more than 1,000 μm, more preferably not less than 10 μm and not more than 500 μm, and still more preferably not less than 20 μm and not more than 300 μm.

Since the amic acid oligomer is in powder form rather than film form, thread form, or lump form, as described later, in a case where an imidization reaction by heating is carried out, the amic acid oligomer can be heated more uniformly than a film and a thread due to its large surface area, and an imide oligomer powder can be produced efficiently.

Further, carrying out heating after uniformly depositing or spraying the amic acid oligomer powder on carbon fibers enables efficient production of a dry prepreg of an imide oligomer. For example, a method for producing a semipreg or a prepreg according to an embodiment of the present invention includes: a step of obtaining an amic acid oligomer powder by the foregoing method for producing an amic acid oligomer powder; and a step of depositing the amic acid oligomer powder on reinforcement fibers and applying pressure to the deposited amic acid oligomer powder.

An amount of residual solvent contained in the amic acid oligomer powder according to an embodiment of the present invention which amic acid oligomer powder has been obtained by the spray drying method is preferably not less than 0% and not more than 50%, more preferably not less than 0% and not more than 30%, and still more preferably not less than 0% and not more than 15%.

### [4. Imide Oligomer, Cured Product, Film]

A cured product according to an embodiment of the present invention may be obtained by heat-curing the amic acid oligomer powder. In a case where the amic acid oligomer powder or the varnish of the amic acid oligomer is heated, an imide oligomer is obtained by a ring-closing reaction of an amic acid.

At this stage, in a case where a heat treatment temperature for imidization of the amic acid oligomer powder is not higher than a melting start temperature of the imide oligomer, the imide oligomer can be obtained while a shape of the amic acid oligomer powder is maintained.

Upon further heating, the imide oligomer melts, and further, an ethynyl group of a 4-(2-phenylethynyl)phthalic acid compound present at a terminal of the imide oligomer reacts with another molecule, thereby causing the imide oligomer after reaction to have a high molecular weight and curing the imide oligomer. Note that a triple bond possessed by the ethynyl group of the 4-(2-phenylethynyl)phthalic acid compound, and a double bond and a single bond each derived from the triple bond are considered to be involved in such a reaction, and a cured product after the reaction has a very complicated structure.

A shape of the cured product according to an embodiment of the present invention is not particularly limited, and the cured product may be molded into a desired shape by any method. Examples of the shape of the cured product according to an embodiment of the present invention include a shape obtained by two-dimensionally or three-dimensionally molding the cured product, such as a film shape, a sheet shape, a rectangular parallelepiped shape, or a rod shape. For example, in a case where the cured product is molded into a film shape, the powder of the amic acid oligomer is applied to a support and heat-cured at not lower than 260° C. and not higher than 500° C. for not less than 5 minutes and not more than 200 minutes, thereby making it possible to obtain a film. That is, an embodiment of the present invention also encompasses a film which is obtained from the cured product according to an embodiment of the present invention (a film-shaped cured product). The film is understood to be a cured product of an imide oligomer.

The cured product according to an embodiment of the present invention can also be obtained by filling a mold such as a die with the amic acid oligomer in powder form, forming a pre-formed body by compression molding at not lower than 10° C. and not higher than 330° C. and not less than 0.1 MPa and not more than 100 MPa for approximately not less than 1 second and not more than 100 minutes, and heating the pre-formed body at not lower than 280° C. and not higher than 500° C. for approximately not less than 10 minutes and not more than 40 hours. In the present specification, values of pressure are all values of actual pressure applied to a sample.

The cured product according to an embodiment of the present invention has a glass transition temperature (Tg) of preferably not lower than 250° C., more preferably not lower than 290° C., and still more preferably not lower than 300° C. In the present specification, the glass transition temperature (Tg) refers to that measured by a method disclosed in Examples described later.

The cured product according to an embodiment of the present invention has a tensile modulus of preferably not less than 2.60 GPa, and more preferably not less than 2.80 GPa. In the present specification, the tensile modulus refers to that measured by a method disclosed in Examples described later.

The cured product according to an embodiment of the present invention has a tensile breaking strength of preferably not less than 100 MPa, and more preferably not less than 110 MPa. In the present specification, the tensile breaking strength refers to that measured by a method disclosed in Examples described later.

The cured product according to an embodiment of the present invention has a tensile elongation at break of preferably not less than 5.0%. In the present specification, the tensile elongation at break refers to that measured by a method disclosed in Examples described later.

### [5. Prepreg]

A prepreg according to an embodiment of the present invention is obtained by impregnating fibers with a granular resin material containing the amic acid oligomer, and, if necessary, evaporatively removing part of a solvent by heating or the like. Alternatively, the prepreg according to an embodiment of the present invention can be obtained from a semipreg described later. The prepreg according to an embodiment of the present invention can be obtained, for example, as follows.

First, the amic acid oligomer in powder form is dissolved in a solvent, or a reaction solution is used as it is, or concentrated or diluted, as appropriate, to obtain a solution composition (varnish) of the amic acid oligomer. The varnish of the amic acid oligomer, the concentration of which has been regulated to a suitable degree, is impregnated into, for example, fibers planarly aligned unidirectionally, a fiber fabric, or the like, and dried in a dryer at not lower than 20° C. and not higher than 180° C. for not less than 1 minute and not more than 20 hours, thereby making it possible to obtain a prepreg.

A content of a resin adhering to the fibers, the fiber fabric, or the like is preferably not less than 10% by weight and not more than 60% by weight, and more preferably not less than 20% by weight and not more than 50% by weight. In the present specification, the content of the resin means a weight of an imide oligomer (resin) derived from the amic acid oligomer and adhering to the fibers, the fiber fabric, or the like, relative to a weight obtained by combining the weight of the imide oligomer (resin) and a weight of the fibers, the fiber fabric, or the like.

An amount of solvent adhering to the fibers, the fiber fabric, or the like is preferably not less than 1% by weight and not more than 30% by weight, more preferably not less than 5% by weight and not more than 25% by weight, and still more preferably not less than 5% by weight and not more than 20% by weight, relative to a total weight of the prepreg. In a case where the amount of the solvent adhering to the fibers, the fiber fabric, or the like is in the above range, handling during layering of the prepreg is easy. Further, a fiber-reinforced composite material exhibiting excellent mechanical strength can be produced by preventing resin outflow during molding of the fiber-reinforced composite material at a high temperature.

An amic acid oligomer powder according to an embodiment of the present invention is a solid, and thus has superior storage stability to an amic acid oligomer solution that has not been formed into powdered form. That is, the amic acid oligomer powder deteriorates by hydrolysis at a slow rate. Thus, the amic acid oligomer powder is also useful as a raw resin in a method for producing a prepreg or the like by impregnating reinforcement fibers with an amic acid oligomer solution (so-called a wet method). That is, keeping the amic acid oligomer in powder form enables long-term storage of the amic acid oligomer. For example, the method for producing a semipreg or a prepreg according to an embodiment of the present invention may include: a step of obtaining an amic acid oligomer powder by the foregoing method for producing an amic acid oligomer powder; a step of dissolving the amic acid oligomer powder in a solvent; and a step of impregnating reinforcement fibers with an obtained amic acid oligomer solution.

Examples of the fibers include inorganic fibers such as carbon fibers, glass fibers, metal fibers, and ceramic fibers, and organic synthetic fibers such as polyamide fibers, polyester-based fibers, polyolefin-based fibers, and novoloid fibers. These fibers may be used alone or in combination of two or more.

In particular, in order for a fiber-reinforced composite material produced from a prepreg to exhibit excellent mechanical characteristics and high heat resistance, the fibers are preferably carbon fibers. The carbon fibers are not particularly limited as long as the carbon fibers are a material that has a carbon content in a range of not less than 85% by weight and not more than 100% by weight and that has a continuous fibrous shape which at least partially has a graphite structure. Examples of such fibers include carbon fibers such as polyacrylonitrile (PAN)-based, rayon-based, lignin-based, and pitch-based carbon fibers. Among these fibers, carbon fibers such as PAN-based or pitch-based carbon fibers are preferable because such carbon fibers are versatile and inexpensive and have high strength.

The carbon fibers are generally subjected to sizing treatment, but may be used as they are. If necessary, it is possible to use fibers in which a small amount sizing agent and/or to remove a sizing agent by an existing method such as an organic solvent treatment or a heat treatment.

The sizing agent is used in an amount of preferably not more than 0.5% by weight, and more preferably not more than 0.2% by weight, relative to the carbon fibers. A sizing agent used for carbon fibers is ordinarily a sizing agent for an epoxy resin, and thus sometimes decomposes at a temperature of not lower than 280° C. at which an amic acid oligomer according to an embodiment of the present invention is cured. Setting, in the above range, the amount of the sizing agent used makes it possible to obtain a high-quality fiber-reinforced composite material in which defects (voids), etc. caused by volatilization of a decomposition product of the sizing agent are reduced.

Further, a carbon fiber bundle may be opened in advance with use of air, a roller, or the like, and a resin or a resin solution may be impregnated into a space between individual carbon fibers. Opening the carbon fiber bundle shortens a resin impregnation distance. This facilitates obtaining a fiber-reinforced composite material in which defects such as voids are further reduced or eliminated.

A form of a fibrous material constituting the prepreg according to an embodiment of the present invention is exemplified by but not particularly limited to structures such as a unidirectional (UD) material, woven fabric (a plain weave, a twill weave, a satin weave, and the like), knitted fabric, braided fabric, and nonwoven fabric. The form of the fibrous material may be selected, as appropriate, in accordance with the purpose thereof, and the above forms can be used alone or in combination.

An obtained prepreg is preferably stored and transported in a state in which either one or each of both surfaces thereof is covered with a resin sheet such as polyethylene terephthalate (PET) or a covering sheet such as paper. The prepreg in such a covered state is stored and transported in the form of, for example, a roll or a sheet cut out from the roll.

### [6. Semipreg and Fiber-Reinforced Composite Material]

A fiber-reinforced composite material according to an embodiment of the present invention may be obtained by layering and heat-curing the prepreg, or may be obtained by adhering the powder of the amic acid oligomer to the fibers and then layering and heat-curing a semipreg and/or a prepreg that is/are produced through a step of fusing the amic acid oligomer. For example, a method for producing the fiber-reinforced composite material according to an embodiment of the present invention includes: a step of obtaining a semipreg or a prepreg by the foregoing method for producing a semipreg or a prepreg; and a step of layering and the semipreg or prepreg and applying pressure to the layered semipreg or prepreg.

In the present specification, the term “semipreg” means an integrated resin-reinforcement fiber composite in which a resin (for example, an amic acid oligomer) is partially impregnated into reinforcement fibers (a semi-impregnated state). A semipreg according to an embodiment of the present invention can be obtained by mixing the powder of the amic acid oligomer with the reinforcement fibers. A prepreg can be obtained from the semipreg. For example, the prepreg can be obtained by further heating and melting the semipreg, thereby impregnating the reinforcement fibers with the resin.

As described earlier, the amic acid oligomer that has an increased molecular weight due to imidization and further heat curing has a very complicated structure. The fiber-reinforced composite material according to an embodiment of the present invention can be obtained, for example, as follows.

The fiber-reinforced composite material can be obtained by cutting the prepreg into a desired size, stacking a predetermined number of sheets, and using an autoclave, a hot press, or the like to heat and dry the sheets at not lower than 200° C. and not higher than 310° C. under atmospheric pressure or reduced pressure for approximately not less than 5 minutes and not more than 40 hours if necessary and then heat-cure the sheets at a temperature of not lower than 280° C. and not higher than 500° C. and a pressure of not less than 0.1 MPa and not more than 100 MPa for approximately not less than 10 minutes and not more than 40 hours. Alternatively, the fiber-reinforced composite material can also be obtained as a laminate obtained by not only using the prepreg but also adhering the powder of the amic acid oligomer to the fibers, then layering a semipreg and/or a prepreg that is/are produced through a step of fusing the amic acid oligomer, and heat-curing the semipreg and/or the prepreg in the same manner as above.

The fiber-reinforced composite material according to an embodiment of the present invention preferably has a glass transition temperature (Tg) of not lower than 300° C., and more preferably not lower than 325° C. In the present specification, the glass transition temperature (Tg) refers to that measured by a method disclosed in Examples described later.

A fiber-reinforced composite material structure may be obtained by inserting the amic acid oligomer formed in a film shape, the powder of the amic acid oligomer, the semipreg, or the prepreg between the fiber-reinforced composite material and a different material or the same material, and heating and melting the amic acid oligomer formed in a film shape, the powder of the amic acid oligomer, the semipreg, or the prepreg for integration thereof. Note here that the different material is not particularly limited, and any material commonly used in this field can be used. Examples of the different material include metal materials having a honeycomb shape and the like and core materials having a sponge shape and the like.

### [7. Application]

The amic acid oligomer, a cured product thereof, a fiber-reinforced composite material, and the like can be used in a wide range of fields that require easy moldability, high heat resistance, and high thermal oxidative stability, including equipment for the aircraft and space industries, vehicle engine (peripheral) members, and general industrial applications such as transfer arms, robot arms, roll materials, friction materials, and sliding members such as bearings. Examples of aircraft members include fan cases, inner frames, rotor blades (fan blades and the like), stator vanes (structural guide vanes (SGVs) and the like), bypass ducts, and various pipes of engines. Preferable examples of vehicle members include brake members, engine members (cylinders, motor cases, air boxes, and the like), and energy regeneration system members.

The present invention is not limited to the embodiments, but can be altered by a skilled person in the art within the scope of the claims. The present invention also encompasses, in its technical scope, any embodiment derived by combining technical means disclosed in differing embodiments.

An embodiment of the present invention may include the following features.
<1> A method for producing the amic acid oligomer powder, including a step of obtaining an amic acid oligomer powder by using a spray drying method to remove a solvent from a varnish of an amic acid oligomer, the amic acid oligomer powder containing a compound selected from the group consisting of general formulas (1), (2), and (3).
<2> The method according to <1>, wherein the compound selected from the group consisting of general formulas (1), (2), and (3) is a compound selected from the group consisting of general formulas (4), (5), and (6).
<3> The method according to <1> or <2>, wherein the amic acid oligomer powder has a particle size of not less than 1 μm and not more than 1,000 μm.
<4> A method for producing a semipreg or a prepreg, including: a step of obtaining an amic acid oligomer powder by the method according to any one of <1> to <3>; and a step of depositing the amic acid oligomer powder on reinforcement fibers and applying pressure to the deposited amic acid oligomer powder.
<5> A method for producing a semipreg or a prepreg, including: a step of obtaining an amic acid oligomer powder by the method according to any one of <1> to <3>; a step of dissolving the amic acid oligomer powder in a solvent; and a step of impregnating reinforcement fibers with an obtained amic acid oligomer solution.
<6> A method for producing a fiber-reinforced composite material, including: a step of obtaining a semipreg or a prepreg by the method according to <4> or <5>; and a step of layering and the semipreg or prepreg and applying pressure to the layered semipreg or prepreg.
<7> An amic acid oligomer powder obtained by the method according to any one of <1> to <3>.

Alternatively, an embodiment of the present invention may include the following features.
<1A> A method for producing an amic acid oligomer powder containing a compound selected from the group consisting of general formulas (1A) to (3A), wherein a spray drying method is used.
<2A> The method according to <1A>, wherein the compound selected from the group consisting of general formulas (1A) to (3A) is a compound selected from the group consisting of general formulas (4A) to (6A).
<3A> The method according to <1A> or <2A>, wherein the amic acid oligomer powder has a particle size of not less than 1 μm and not more than 1,000 μm.
<4A> A method for producing a semipreg or a prepreg, wherein pressure is applied to the amic acid oligomer powder according to any one of <1A> to <3A> that is deposited on reinforcement fibers.
<5A> A method for producing a fiber-reinforced composite material, wherein the semipreg or prepreg according to <4A> is layered, and pressure is applied thereto.
<6A> An amic acid oligomer powder comprising a compound selected from the group consisting of general formulas (1A) to (3A).
<7A> The amic acid oligomer powder according to <6A>, wherein the compound selected from the group consisting of general formulas (1A) to (3A) is a compound selected from the group consisting of general formulas (4A) to (6A).
<8A> The amic acid oligomer powder according to <6A> or <7A>, wherein the amic acid oligomer powder has a particle size of not less than 1 μm and not more than 1,000 μm.

### EXAMPLES

The following description will discuss an embodiment of the present invention in more detail with reference to Examples and Comparative Examples. Note, however, that the present invention is not limited to these examples. An embodiment of the present invention can be altered, as appropriate, within the scope of the gist disclosed herein. The present invention also includes, in its technical scope, embodiments achieved by altering the embodiment. In the following Examples and Comparative Examples, the term “parts” means “parts by weight”, and the term “%” means “% by weight”.

Examples and Comparative Examples for describing the present invention are shown below but do not limit the present invention. First, measurement conditions for each physical property were as follows.

### [Test Method]

### NMR Measurement

A sample was dissolved in a deuterated DMF solution and then measured with use of a 400 MHz NMR apparatus manufactured by Bruker Corporation.

Measurement of particle size of particles A scanning electron microscope (SEM) apparatus manufactured by JEOL Ltd. was used to place a randomly sampled amic acid oligomer powder on a stage of the SEM apparatus, randomly select at least 10 particles present within an observation field of view of 1,500 μm square, and observe and measure a diameter of each of the particles with use of a function of accompanying software.

### Glass Transition Temperature (Tg)

For a resin in powder form and a film-shaped cured product, a DSC20 differential scanning calorimeter (manufactured by TA Instruments) was used to measure a DSC curve under conditions of a nitrogen stream (50 mL/min) and a heating rate of 20° C./min. A temperature at an intersection of tangents at an inflection point of the DSC curve was regarded as a glass transition temperature. For a composite material, a DHR-10 dynamic viscoelasticity analyzer (manufactured by TA Instruments) was used to measure a storage modulus curve under conditions of single cantilever mode, a nitrogen stream (50 mL/min), and a heating rate of 10° C./min. A temperature at an intersection of tangents at an inflection point of the storage modulus curve was taken as the glass transition temperature.

### Tensile Modulus, Tensile Breaking Strength, and Tensile Elongation at Break

The film-shaped cured product was subjected to a tensile test with use of a tensile tester TENSILON/UTM-II-20 (manufactured by Orientec Co., Ltd.). The tensile test was carried out at room temperature and at a tensile speed of 5 mm/min, and a test piece had a shape with a size of 30 mm in length and 3 mm in width.

### [Raw Material Compound]

In Examples and Comparative Examples described below, raw material compounds and solvents are indicated by the following notations.
PMDA: 1,2,4,5-benzenetetracarboxylic dianhydride (literature melting point: 286° C.)
PDPE: 2-phenyl-4,4′-diaminodiphenyl ether (literature melting point: 128° C.)
BAFL: 9,9-bis(4-aminophenyl)fluorene (literature melting point: 236° C.)
PEPA: 4-(2-phenylethynyl)phthalic anhydride (literature melting point: 149° C. to 154° C.)
PA: Phthalic anhydride
2-ME: 2-methoxyethanol (literature boiling point: 124° C.)
1,3-Dox: 1,3-dioxolane (literature boiling point: 76° C.)
MeOH: Methanol (literature boiling point: 65° C.)
NMP: N-methyl-2-pyrrolidone (literature boiling point: 202° C.).

### Example 1

After a 2,000 mL separable flask provided with a stirring blade was filled with nitrogen, 249.79 g (904 mmol) of PDPE and 35.00 g (100 mmol) of BAFL as diamine components and 1,039.64 g of 2-ME as a solvent were charged, and stirring was carried out at 55° C. for 30 minutes to obtain a uniform reaction solution. Next, 175.27 g (804 mmol) of PMDA as an acid component was charged into the reaction solution, stirring was carried out at 55° C. for 2 hours, and then stirring was carried out at room temperature for 16 hours to obtain a uniform reaction solution. Thereafter, the reaction solution was heated to 55° C., 99.74 g (402 mmol) of PEPA as a terminal capping agent component was further charged, and stirring was carried out for 4 hours to obtain a uniform amic acid oligomer varnish free of insoluble components (solid content concentration: 35% by weight).

The solution was diluted 1.3-fold with 2-ME and fed to an SB-39 spray dryer (manufactured by PRECI Co., Ltd.) at 25 g/min. A two-fluid nozzle droplet production device was used to carry out spraying into a chamber of the spray dryer at an inlet temperature of the spray dryer of 100° C. and an internal temperature of the chamber of the spray dryer of 76° C. to obtain a powder of an amic acid oligomer. The powder of the amic acid oligomer contained the solvent in an amount of 8.9%. As a result of GPC measurement, the powder of the amic acid oligomer had a number average molecular weight of 2,765 and a weight average molecular weight of 4,717. Further, the powder of the amic acid oligomer contained a compound selected from the group consisting of general formulas (1), (2), and (3), and m=3.5 and n=0.5.

The above product was dissolved again in 2-ME, so that it was possible to produce an amic acid oligomer varnish having a solid content concentration of 35% by weight. Further, as a result of GPC measurement after storage of the product at room temperature for 3 months, no difference was observed in the number average molecular weight or the weight average molecular weight, and it was found that cleavage and decomposition of the amic acid oligomer due to, for example, hydrolysis did not occur. The product after storage was dissolved again in 2-ME, so that it was possible to produce an amic acid oligomer varnish having a solid content concentration of 35% by weight.

### Example 2

A prepreg impregnated with an imide oligomer resin was obtained by subjecting a uniform deposition of the powder of the amic acid oligomer, which powder had been obtained in Example 1, in the form of plain-woven carbon fibers to hot press molding at 300° C. for 5 minutes. Sixteen sheets of the prepreg were produced and then layered, and hot press molding was carried out in a press at 370° C. and 1 MPa to produce a carbon fiber composite material plate. The produced composite material plate contained 55% by weight of a cured resin and 45% by weight of carbon fibers. The produced composite material plate had a Tg of 350° C.

### Example 3

After a 75 L reactor provided with a stirring blade was filled with argon, 11.71 kg (42.38 mol) of PDPE and 1.64 kg (4.71 mol) of BAFL as diamine components and 48.75 kg of 2-ME as a solvent were charged, and stirring was carried out at 55° C. for 90 minutes to obtain a uniform reaction solution. Next, after the reaction solution was adjusted to 40° C., 8.22 kg (37.69 mol) of PMDA as an acid component was charged, and stirring was carried out at 40° C. for 17 hours to obtain a uniform reaction solution. Into the reaction solution, 4.68 kg (18.85 mol) of PEPA as a terminal capping agent component was further charged, and stirring was carried out at 40° C. for 4 hours to obtain a uniform amic acid oligomer varnish free of insoluble components (solid content concentration: 35% by weight).

The solution was diluted 1.3-fold with 2-ME and fed to a P260 large spray dryer (manufactured by PRECI Co., Ltd.) at 310 g/min. A rotary atomizer droplet production device was used to carry out spraying into a chamber of the spray dryer at an inlet temperature of the spray dryer of 130° C. and an internal temperature of the chamber of the spray dryer of 103° C. to obtain a powder of an amic acid oligomer. The powder of the amic acid oligomer contained the solvent in an amount of 9.9%. Further, the powder of the amic acid oligomer contained a compound selected from the group consisting of general formulas (1), (2), and (3), and m=3.5 and n=0.5.

### Example 4

The solution obtained in Example 3 was diluted 1.3-fold with 2-ME and then fed to a P260 large spray dryer (manufactured by PRECI Co., Ltd.) at 157 g/min. A rotary atomizer droplet production device was used to carry out spraying into a chamber of the spray dryer at an inlet temperature of the spray dryer of 150° C. and an internal temperature of the chamber of the spray dryer of 118° C. to obtain a powder of an amic acid oligomer. The powder of the amic acid oligomer contained a solvent in an amount of 9.0%. Further, the powder of the amic acid oligomer contained a compound selected from the group consisting of general formulas (1), (2), and (3), and m=3.5 and n=0.5.

### Example 5

After a 75 L reactor provided with a stirring blade was filled with argon, 11.71 kg (42.38 mol) of PDPE and 1.64 kg (4.71 mol) of BAFL as diamine components and 24.375 kg of 1,3-Dox and 24.375 kg of MeOH as solvents were charged, and stirring was carried out at 40° C. for 90 minutes to obtain a uniform reaction solution. Next, after the reaction solution was adjusted to 35° C., 8.22 kg (37.69 mol) of PMDA as an acid component was charged, stirring was carried out for 1 hour, and then stirring was carried out at 30° C. for 17 hours to obtain a uniform reaction solution. Into the reaction solution, 4.68 kg (18.85 mol) of PEPA as a terminal capping agent component was further charged, and stirring was carried out at 45° C. for 4 hours to obtain a uniform amic acid oligomer varnish free of insoluble components (solid content concentration: 35% by weight).

An obtained solution was fed to a P260 large spray dryer (manufactured by PRECI Co., Ltd.) at 165 g/min. A rotary atomizer droplet production device was used to carry out spraying into a chamber of the spray dryer at an inlet temperature of the spray dryer of 90° C. and an internal temperature of the chamber of the spray dryer of 75° C. to obtain a powder of an amic acid oligomer. The powder of the amic acid oligomer contained the solvents in an amount of 12.9%. Further, the powder of the amic acid oligomer contained a compound selected from the group consisting of general formulas (1), (2), and (3), and m=3.5 and n=0.5.

### Example 6

After a 75 L reactor provided a stirring blade was filled with argon, 10.91 kg (39.48 mol) of PDPE and 1.53 kg (4.39 mol) of BAFL as diamine components and 36.00 kg of 2-ME as a solvent were charged, and stirring was carried out at 55° C. for 90 minutes to obtain a uniform reaction solution. Next, after the reaction solution was adjusted to 40° C., 7.65 kg (35.07 mol) of PMDA as an acid component was charged, and stirring was carried out at 40° C. for 14 hours to obtain a uniform reaction solution. Into the reaction solution, 0.65 kg (4.39 mol) of PA and 3.27 kg (13.17 mol) of PEPA as terminal capping agent components were further charged, and stirring was carried out at 40° C. for 4 hours to obtain a uniform amic acid oligomer varnish free of insoluble components (solid content concentration: 40% by weight).

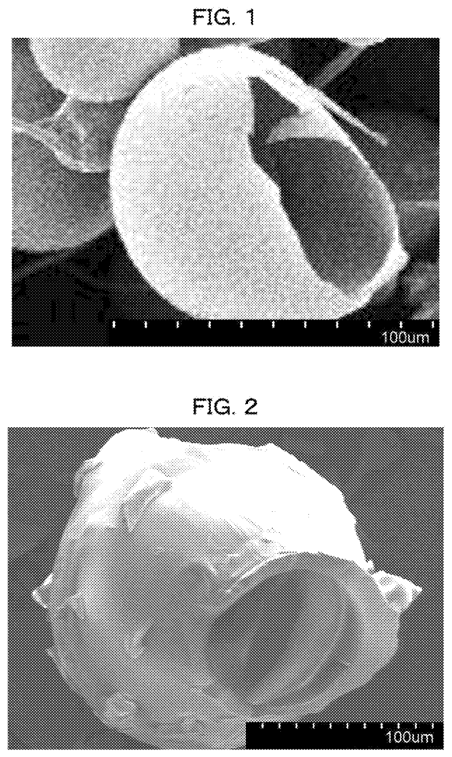

An obtained solution was diluted 2-fold with 2-ME and then fed to a TR160 medium-sized spray dryer (manufactured by ERECI Co., Ltd.) at 52 g/min. A rotary atomizer droplet production device was used to carry out spraying into a chamber of the spray dryer at an inlet temperature of the spray dryer of 250° C. and an internal temperature of the chamber of the spray dryer of 143° C. to obtain a powder of an amic acid oligomer. The powder of the amic acid oligomer contained the solvent in an amount of 8.1%. Further, the powder of the amic acid oligomer contained a compound selected from the group consisting of general formulas (1), (2), and (3), and m=3.5 and n=0.5. FIG. 1 shows a result of SEM observation of the powder of the amic acid oligomer. As can be seen from FIG. 1, an amic acid oligomer powder obtained by a spray drying method was found to have a shape of a shell-derived powder. Further, the amic acid oligomer powder was heated in a hot-air oven at 250° C. for 1 hour to carry out imidization. FIG. 2 shows a result of SEM observation of an imide oligomer powder obtained after imidization. As can be seen from FIG. 2, the imide oligomer powder thus obtained was found to have a shape of a shell-derived powder.

### Example 7

After a 2,000 mL separable flask provided with a stirring blade was filled with nitrogen, 231.24 g (837 mmol) of PDPE and 32.40 g (93 mmol) of BAFL as diamine components and 986 g of 2-ME as a solvent were charged, and stirring was carried out at 55° C. for 30 minutes to obtain a uniform reaction solution. Next, after the reaction solution was adjusted to 40° C., 152.11 g (697 mmol) of PMDA as an acid component was charged, stirring was carried out at 40° C. for 2 hours, and then stirring was carried out at room temperature for 15 hours to obtain a uniform reaction solution. Thereafter, after the reaction solution was heated to 40° C., 115.41 g (465 mmol) of PEPA as a terminal capping agent component was further charged, and stirring was carried out for 4 hours to obtain a uniform amic acid oligomer varnish free of insoluble components (solid content concentration: 35% by weight).

An obtained solution was diluted 1.5-fold with 2-ME and then fed to a TR160 medium-sized spray dryer (manufactured by PRECI Co., Ltd.) at 52 g/min. A rotary atomizer droplet production device was used to carry out spraying into a chamber of the spray dryer at an inlet temperature of the spray dryer of 180° C. and an internal temperature of the chamber of the spray dryer of 112° C. to obtain a powder of an amic acid oligomer. The powder of the amic acid oligomer contained the solvent in an amount of 10.7%. Further, the powder of the amic acid oligomer contained a compound selected from the group consisting of general formulas (1), (2), and (3), and m=2.6 and n≥0.4.

### Comparative Example 1

After the solution produced in Example 1 was placed in a sample bottle and left standing at room temperature for 2 weeks, the solution reached a gel state, and some insoluble precipitate was observed to precipitate. Such a phenomenon is considered to be attributable to hydrolysis of the amic acid oligomer in the solution. An obtained gel was heated again but did not dissolve.

### Reference Experimental Example 1

An imide oligomer was obtained by heating, in an oven at 260° C. for 1 hour, a powder product of the amic acid oligomer obtained in Example 1 to carry out imidization. The imide oligomer had a Tg of 228° C. The imide oligomer had a minimum melt viscosity of 580 Pa·s (353° C.).

A powder of the imide oligomer was heat-cured at 370° C. for 1 hour with use of a hot press to obtain a film-shaped cured product. The cured product had a Tg of 360° C.

### Example 8

An amic acid oligomer varnish obtained by dissolving again, in 2-ME, a powder product of the amic acid oligomer obtained in Example 1 to have a solid content concentration of 35% by weight was used. After the amic acid oligomer varnish was impregnated into 30 cm-square plain-woven carbon fibers and semi-dried, 16 sheets of prepreg were obtained. The prepreg contained 45% by weight of the amic acid oligomer, 20% by weight of the solvent, and 35% by weight of the carbon fibers.

### Example 9

The sheets of the prepreg obtained in Example 8 and impregnated with the amic acid oligomer varnish were layered, and during heating up to 370° C. in a press, removal of the solvent, imidization, and resin melting were carried out. Next, hot press molding was carried out in the press at 370° C. and 1 MPa to produce a carbon fiber composite material plate. The produced composite material plate contained 55% by weight of a cured resin and 45% by weight of carbon fibers. The produced composite material plate had a Tg of 350° C.

### Example 10

An amic acid oligomer varnish obtained by dissolving again, in 2-ME, a powder product of the amic acid oligomer obtained in Example 3 to have a solid content concentration of 35% by weight was used. After the amic acid oligomer varnish was impregnated into 15 cm-square plain-woven carbon fibers and semi-dried, 16 sheets of prepreg were obtained. The prepreg contained 31% by weight of the amic acid oligomer, 21% by weight of the solvent, and 48% by weight of the carbon fibers.

### Example 11

The sheets of the prepreg obtained in Example 10 and impregnated with the amic acid oligomer varnish were layered, and during heating up to 370° C. in a press, removal of the solvent, imidization, and resin melting were carried out. Next, hot press molding was carried out in the press at 370° C. and 1 MPa to produce a carbon fiber composite material plate. The produced composite material plate contained 38% by weight of a cured resin and 62% by weight of carbon fibers. The produced composite material plate had a Tg of 348° C.

### [Comparative Example 2] Reprecipitation Method

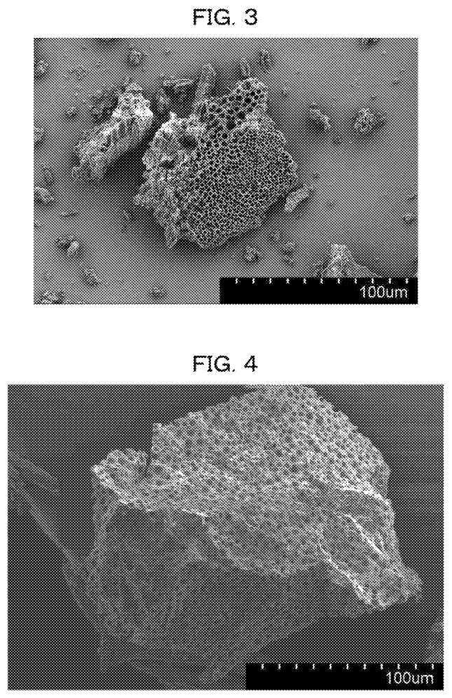

To a 2,000 mL three-necked flask provided with a thermometer, a stirrer, and a nitrogen introduction tube, 220.79 g (0.80 mol) of PDPE, 30.95 g (0.089 mol) of BAFL, and 860 mL of NMP were added. After dissolution, 155.04 g (0.711 mol) of PMDA and 33 mL of NMP were added. In the flask, polymerization reaction was carried out under a nitrogen stream at room temperature for 2.5 hours, at 60° C. for 1.5 hours, and at room temperature for another 1 hour to generate an amic acid oligomer. To an obtained reaction solution, 88.22 g (0.355 mol) of PEPA was added, a reaction was carried out under a nitrogen stream at room temperature for 12 hours to terminally modify the amic acid oligomer, and subsequently stirring was carried out at 195° C. for 5 hours to form an imide bond. After cooling, part of an obtained reaction solution was poured into 500 mL of ion-exchanged water, and a precipitated powder was separated by filtration. Washing was carried out with 80 mL of methanol for 30 minutes, and the powder obtained by filtration was dried under reduced pressure at 130° C. for 1 day to obtain an imide oligomer powder. FIG. 3 shows a result of SEM observation of the imide oligomer powder. As can be seen from FIG. 3, an imide oligomer powder obtained by a reprecipitation method was observed to have a shape in a porous state or a foamed state on a surface thereof. Further, confirmation of the inside of the obtained powder revealed that the powder was not in a state of a shell-derived powder but was in a porous state, a foamed state, or a solid state.

### [Comparative Example 3] Pulverization Method

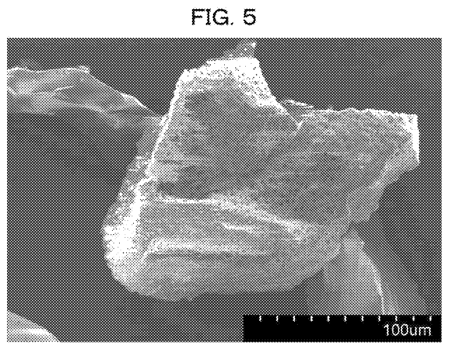

The amic acid oligomer varnish obtained in Example 3 was poured into an aluminum tray, placed in a convection oven, and heated at 130° C. for 1.5 hours to remove the solvent. Subsequently, the aluminum tray was placed in a vacuum oven and dried under reduced pressure at 90° C. for 2 hours. An obtained lump of the amic acid oligomer was pulverized to obtain a powder of the amic acid oligomer. FIG. 4 shows a result of SEM observation of the powder of the amic acid oligomer. As can be seen from FIG. 4, an amic acid oligomer powder obtained by a pulverization method was observed to have a shape in a porous state or a foamed state on a surface thereof. Further, confirmation of the inside of the obtained powder revealed that the powder was not in a shell-derived state but was in a porous state, a foamed state, or a solid state. Further, the powder was heated in a convection oven at 250° C. for 1 hour to carry out imidization. FIG. 5 shows a result of SEM observation of an imide oligomer powder obtained after imidization. As can be seen from FIG. 5, an imide oligomer powder obtained by the pulverization method had a shape in a porous state or a foamed state on a surface thereof. Further, confirmation of the inside of the obtained powder revealed that the powder was not in a state of a shell-derived powder but was in a porous state, a foamed state, or a solid state.

### [Comparison Between Amic Acid Oligomer Solution (Varnish) and Amic Acid Oligomer Powder]

Comparative Example 1 shows that the amic acid oligomer in the solution completely deteriorates (gels) after 2 weeks at room temperature. In contrast, Example 1 shows that the amic acid oligomer powder does not deteriorate even after 3 months at room temperature. Furthermore, Reference Experimental Examples 2 and 4 show that a prepreg can be produced from a varnish obtained by dissolving an amic acid oligomer powder in a solvent. Moreover, Reference Experimental Examples 3 and 5 show that a fiber-reinforced composite material can be produced from the prepreg.

That is, the inventors of the present invention have clarified through the present series of studies that the following production methods are excellent.
Production Method 1. A method for producing a prepreg, including the following steps:
Step 1. a step of using a spray drying method to produce an amic acid oligomer powder containing a compound selected from the group consisting of general formulas (1), (2), and (3);
Step 2. a step of producing an amic acid oligomer solution by dissolving, in a solvent, the amic acid oligomer powder produced in Step 1; and
Step 3. a step of producing a prepreg from reinforcement fibers and the amic acid oligomer solution produced in Step 2.
Production Method 2. The method according to Production Method 1, wherein the compound selected from the group consisting of general formulas (1), (2), and (3) is a compound selected from the group consisting of general formulas (4), (5), and (6).
Production Method 3. A method for producing a fiber-reinforced composite material, wherein the prepreg obtained by Production Method 1 or 2 is layered, and pressure is applied thereto.

### INDUSTRIAL APPLICABILITY

An embodiment of the present invention can be used in a wide range of fields that require easy moldability, high heat resistance, and high thermal oxidative stability, including equipment for the aircraft and space industries, general industrial applications, and vehicle engine (peripheral) members.

1. A method for producing an amic acid oligomer powder, comprising a step of obtaining an amic acid oligomer powder by using a spray drying method to remove a solvent from a varnish of an amic acid oligomer,
the amic acid oligomer powder containing a compound selected from the group consisting of general formulas (1), (2), and (3): 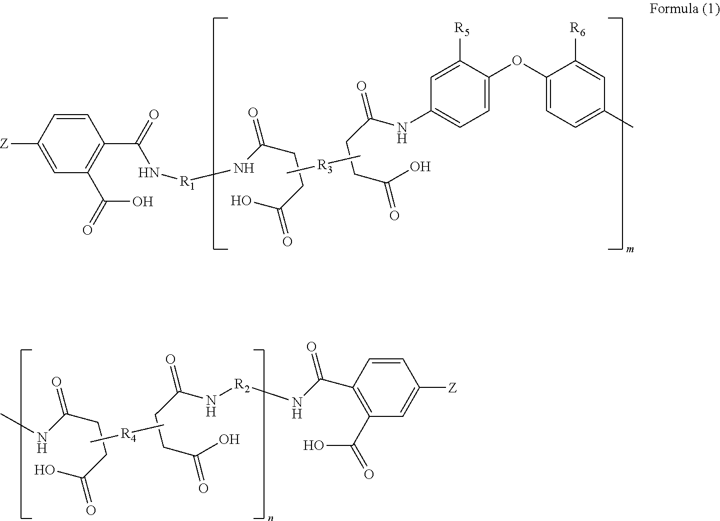
where R₁ and R₂ each represent a divalent aromatic diamine residue, R₃ and R₄ each represent a tetravalent aromatic carboxylic acid residue, two amide groups bonded to R₃ and R₄ are present in trans- or cis-positions, R₅ and R₆ each represent a hydrogen atom or a phenyl group, at least one of R₅ and R₆ is a phenyl group, m and n satisfy the following relationships: m≥1, n≥0, 1≤m+n≤20, and 0.05≤m/(m+n)≤1, repeating units formed by m and n may be arranged in a block or random manner, and Z represents a hydrogen atom or a 2-phenylethynyl group; 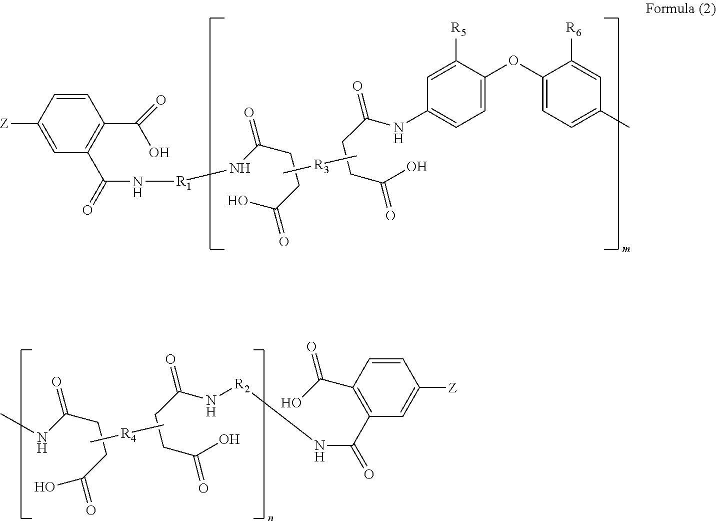
where R₁ and R₂ each represent a divalent aromatic diamine residue, R₃ and R₄ each represent a tetravalent aromatic carboxylic acid residue, two amide groups bonded to R₃ and R₄ are present in trans- or cis-positions, R₅ and R₆ each represent a hydrogen atom or a phenyl group, at least one of R₅ and R₆ is a phenyl group, m and n satisfy the following relationships: m≥1, n≥0, 1≤m+n≤20, and 0.05≤m/(m+n)≤1, repeating units formed by m and n may be arranged in a block or random manner, and Z represents a hydrogen atom or a 2-phenylethynyl group; and 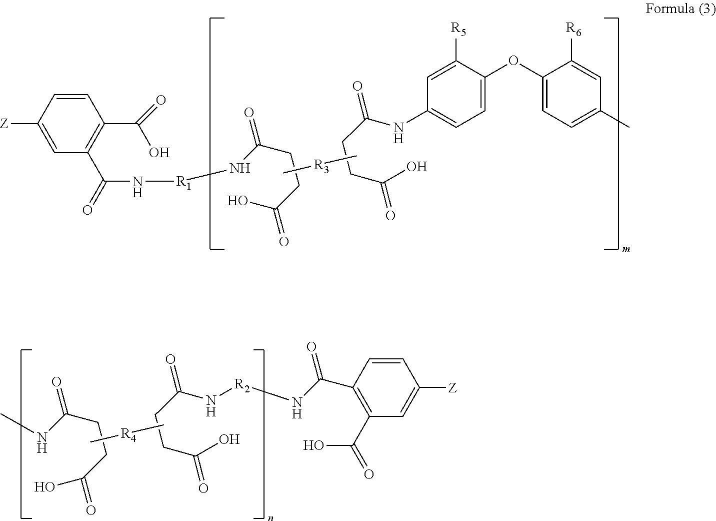
where R₁ and R₂ each represent a divalent aromatic diamine residue, R₃ and R₄ each represent a tetravalent aromatic carboxylic acid residue, two amide groups bonded to R₃ and R₄ are present in trans- or cis-positions, R₅ and R₆ each represent a hydrogen atom or a phenyl group, at least one of R₅ and R₆ is a phenyl group, m and n satisfy the following relationships: m≥1, n≥0, 1≤m+n≤20, and 0.05≤m/(m+n)≤1, repeating units formed by m and n may be arranged in a block or random manner, and Z represents a hydrogen atom or a 2-phenylethynyl group.

2. The method according to claim 1, wherein the compound selected from the group consisting of general formulas (1), (2), and (3) is a compound selected from the group consisting of general formulas (4), (5), and (6): 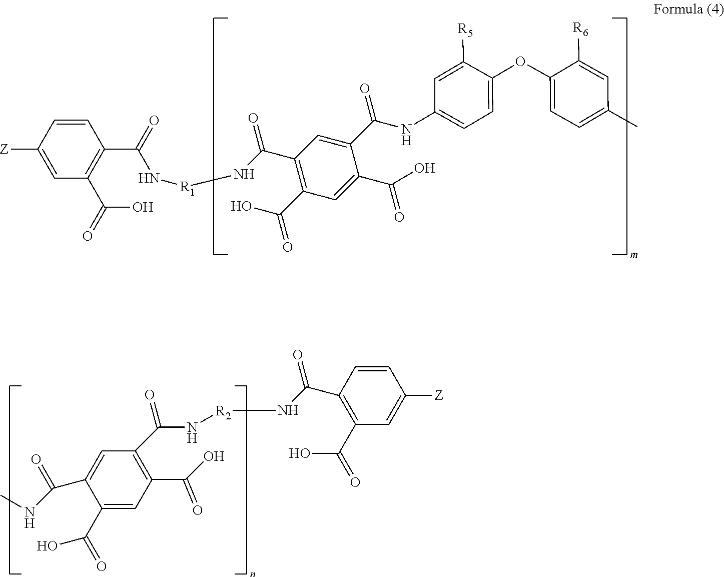
where R₁ and R₂ each represent a divalent aromatic diamine residue, two amide groups bonded to tetravalent benzene rings corresponding to R₃ and R₄ in formula (1) are present in trans- or cis-positions, R₅ and R₆ each represent a hydrogen atom or a phenyl group, at least one of R₅ and R₆ is a phenyl group, m and n satisfy the following relationships: m≥1, n≥0, 1≤m+n≤20, and 0.05≤m/(m+n)≤1, repeating units formed by m and n may be arranged in a block or random manner, and Z represents a hydrogen atom or a 2-phenylethynyl group; 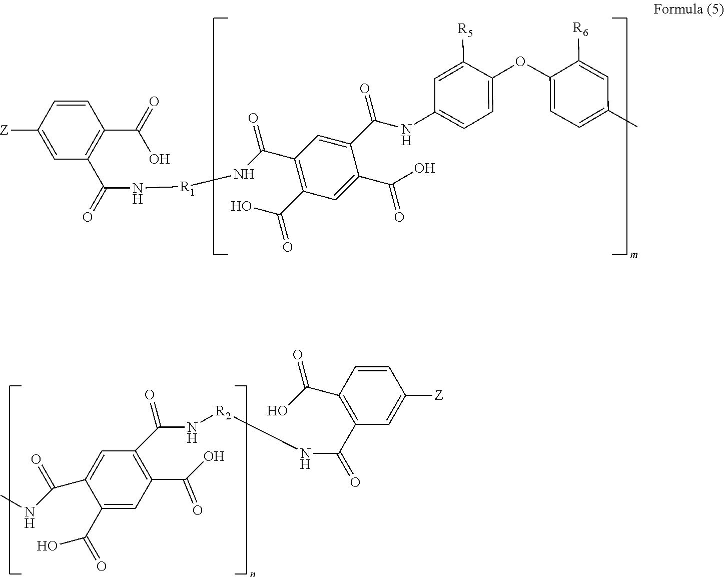
where R₁ and R₂ each represent a divalent aromatic diamine residue, two amide groups bonded to tetravalent benzene rings corresponding to R₃ and R₄ in formula (2) are present in trans- or cis-positions, R₅ and R₆ each represent a hydrogen atom or a phenyl group, at least one of R₅ and R₆ is a phenyl group, m and n satisfy the following relationships: m≥1, n≥0, 1≤m+n≤20, and 0.05≤m/(m+n)≤1, repeating units formed by m and n may be arranged in a block or random manner, and Z represents a hydrogen atom or a 2-phenylethynyl group; and 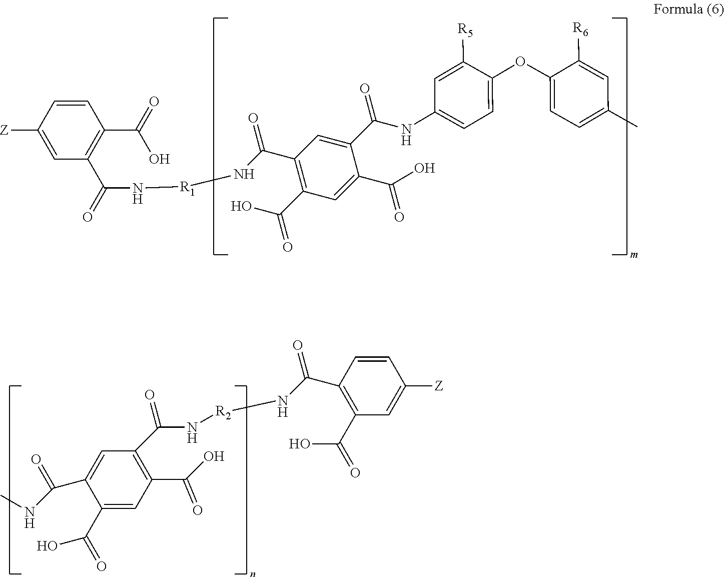
where R₁ and R₂ each represent a divalent aromatic diamine residue, two amide groups bonded to tetravalent benzene rings corresponding to R₃ and R₄ in formula (3) are present in trans- or cis-positions, R₅ and RH each represent a hydrogen atom or a phenyl group, at least one of R₅ and R₆ is a phenyl group, m and n satisfy the following relationships: m≥1, n≥0, 1≤m+n≤20, and 0.05≤/(m+n)≤1, repeating units formed by m and n may be arranged in a block or random manner, and Z represents a hydrogen atom or a 2-phenylethynyl group.

3. The method according to claim 1, wherein the amic acid oligomer powder has a particle size of not less than 1 μm and not more than 1,000 μm.

4. A method for producing a semipreg or a prepreg, comprising:
a step of obtaining an amic acid oligomer powder by the method according to claim 1; and
a step of depositing the amic acid oligomer powder on reinforcement fibers and applying pressure to the deposited amic acid oligomer powder.

5. A method for producing a semipreg or a prepreg, comprising:
a step of obtaining an amic acid oligomer powder by the method according to claim 1;
a step of dissolving the amic acid oligomer powder in a solvent; and
a step of impregnating reinforcement fibers with an obtained amic acid oligomer solution.

6. A method for producing a fiber-reinforced composite material, comprising:
a step of obtaining a semipreg or a prepreg by the method according to claim 4; and
a step of layering the semipreg or the prepreg and applying pressure to the layered semipreg or prepreg.

7. An amic acid oligomer powder obtained by the method according to claim 1.
